(19) United States
(12) Patent Application Publication
(10) Pub. No.: US 2008/0201118 A1
(43) Pub. Date: Aug. 21, 2008

(54) Modeling a web page on top of HTML elements level by encapsulating the details of HTML elements in a component, building a web page, a website and website syndication on browser-based user interface

(76) Inventor: FAN LUO, ANAHEIM, CA (US)

Correspondence Address: FAN LUO, 2535 WEST LINCOLN AVENUE, # 69, ANAHEIM, CA, 92801, US

(21) Appl. No.: 11/676,261

(22) Filed: Feb. 16, 2007

(51) Int. Cl. G06F 7/60; G06F 15/16; G06F 3/00

(52) U.S. Cl. 703/2; 709/204; 715/748

(57) ABSTRACT

A component model is invented for modeling a web page. A web page and website are constructed through component assembling. Components encapsulate the details of HTML elements from a user in the construction process. By exposing component as a service, a component can be reused in other websites and enable the syndication of websites. An abstract page represents a web page; an abstract mosaic represents a component or part of a web page. A mosaic may be bound to any meaningful information locally or remotely. Mosaics are hanged on a page at different row and column positions to make up a pattern for presenting a web page. A mosaic can be hanged on by other mosaics the same way as mosaics hanged on a page, the nested level can be up to any.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED

A computer program listing appendix of the preferred embodiment of the present invention has been submitted as electronic files and contains the following files and byte sizes: DatabaseTables.txt, 13 KB; Entities.txt, 388 KB; EntityPresentations.txt, 253 KB; ExploreXXXXXs.txt, 435 KB; FeaXXXXXs.txt, 75 KB; HtmlElements.txt, 48 KB; ManageXXXXXs.txt, 605 KB; MapXXXXXs.txt, 122 KB; Scripts.txt, 16 KB; ServletBase.txt, 30 KB; ServletProcessor.txt, 50 KB; ServletSession.txt, 7 KB which is hereby incorporated by reference as if set forth in full in the present invention.

### BACKGROUND OF THE INVENTION

Field of the Invention: the present invention relates generally to computing systems, and particularly to the modeling of a web page on component level, which provides a system and method for assembling and building a web page, a website, and website syndication.

Since the birth of Internet and World Wide Web, lots of tools and methods are developed to author a web page either offline (Macromedia Studio, Microsoft FrontPage, Dreamweaver, Adobe Creative Suite, to name a few), or online dynamically which at majority of the time is database-driven (Google Page Creator, Yahoo GEOCITIES, etc.). Typically they go straight down to the HTML specifications and provide functions and features of implementing html elements.

The lack of an abstract modeling on a web page itself is the common nature of these tools and methods. This nature is often reflected on the fact that deep learning curve on the tools and thorough understanding of HTML elements and specifications are needed to author a web page better. Almost all of the tools provide templates for an author to use and build with superb capabilities on creating a web page, however it is still not easy for a layperson. A web page is either built from a base level of html elements or from the topmost level where a web page is made up of framesets and frames which references other web pages. There is a shortage on the middle ground for modeling a web page on component level.

As for website syndication for the purpose of reusing a section of a web page, different versions of RSS (Really Simple Syndication) and Atom specifications use XML as their data format and delivery its information as an XML file called an “RSS feed”, “webfeed”, “RSS stream”, or “RSS channel”. Programs known as feed readers or aggregators can check a list of feeds on behalf of a user and display any updated articles that they find. A component model on a web page is needed for providing a new ground for website syndication.

### BRIEF SUMMARY OF THE INVENTION

A higher level of modeling on a web page on top of HTML elements level is invented for building a web page and website by encapsulating the details of HTML elements in a component and subsequently assembling components into a web page. By exposing component as a service, a component can be reused in other websites and enable syndication of websites.

An abstract page is defined and used to represent a web page; an abstract mosaic is defined and used to represent a component or part of a web page, a mosaic can be bound to any meaningful information either locally or remotely, a mosaic can be exposed as a service. A mosaic or mosaics can be hanged on a page at different row and column positions to make up a pattern for presenting a web page. By manipulating the row and column positions of mosaics, different pattern for presenting a web page is achieved. Further, a mosaic can be hanged on by other mosaic or mosaics the same way as mosaics hanged on a page. The nested level can be up to any. Further a mosaic bound with proper information for a web page's head section can be hanged on or said injected into the head section of a web page.

Such an orderly multi-layered structure provides a mechanism for a group of synchronized threads simultaneously work together to generate a web page in an efficient and speedy way. A hierarchy of buffers accommodates the process to store generated content temporarily and orderly to make into a web page. The nested or cascade nature of this structure is intrinsically identical with Cascading Style Sheets (CSS) mechanism, and each component's styles can be individually specified and cascaded from the very bottom to the top.

A page, when specified as directory type, can hold other pages as its child and provide a directory tree structure for management and access. A page can be just a page itself or it can be mapped to a mosaic; a page can be mapped to an entity such as a picture or a video, a page can also be mapped to a function such as a searchbox, a page can also be mapped to a remote information resource, in all cases, an entity, a function, or a remote information service is bound with a mosaic which is hanged on the mapped page at a pre-specified position. This tree structure enables the management and access of vast amount of pages and variety of contents as well as related tree operations and functions. Such a structure can be used to map a local file directory for access from a web browser and generate an eBook for offline viewing as well. Permission and access control mechanisms are defined for the creation, management, and accessibility of pages.

### BRIEF DESCRIPTION OF THE SEVERAL VIEWS OF THE DRAWING(S)

FIG. 1 is an exemplary embodiment of a Page and illustrates Mosaics hanged on the Page and the Mosaics are grouped into slices according to their hanging position's row value (X value);

FIG. 2 is an exemplary embodiment of a nested Mosaic and illustrates Mosaics hanged on the nested Mosaic and the hanged Mosaics are grouped into slices according to their hanging position's row value (X value);

FIG. 3 is an exemplary embodiment of a hierarchy of threads associated with a web page's generation process;

FIG. 4 is an exemplary embodiment of a hierarchy of buffers with its associated object keys in a web page's generation process;

FIG. 5 is an exemplary embodiment of viewing a web page of a Page in a browser;

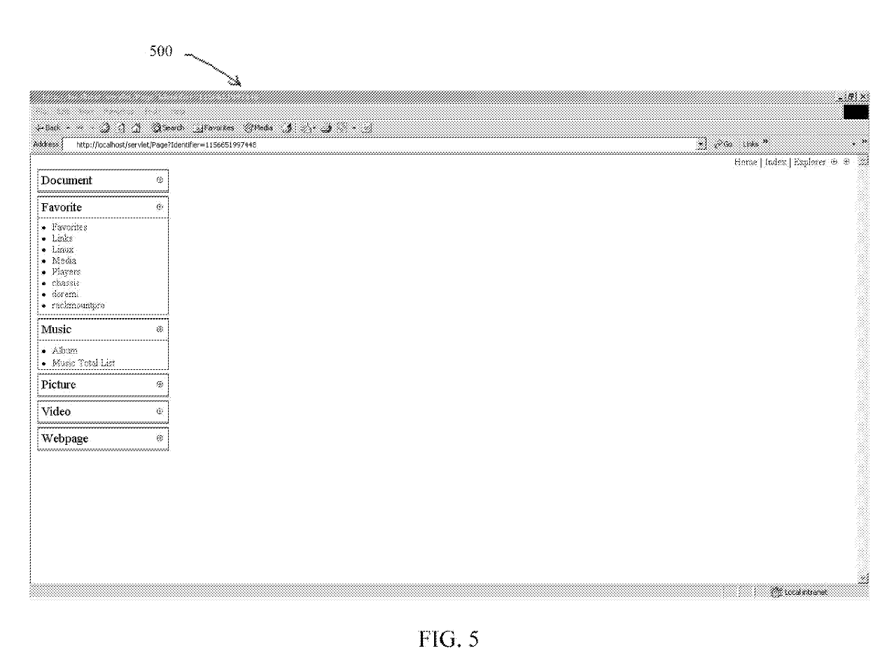

FIG. 6 is an exemplary embodiment of a browser-based user interface for viewing and navigation of directory structure of Pages and for creating and managing of Pages;

FIG. 7 is an exemplary embodiment of a browser-based user interface for managing the accessibility of Pages;

FIG. 8 is an exemplary embodiment of a browser-based user interface for displaying and assembling a Page in view mode;

FIG. 9 is an exemplary embodiment of a browser-based user interface for displaying and assembling a Page in edit mode;

FIG. 10 is an exemplary embodiment of a browser-based user interface for displaying and managing CSS elements' style sheets information of a Page; and

FIG. 11 is an exemplary embodiment of a browser-based user interface for displaying and managing a list of selected local folders and its specified entity types.

### DETAILED DESCRIPTION OF THE INVENTION

A web page's underlying html file, whether statically stored in or dynamically generated by a web application server, when requested by a user, is transferred to and presented in the user's web browser. A web page can present many kind of information for presentation and interaction.

A web page's html file starts with an open tag <html> and ends with a close tag </html>. An html file is composed of a head section which starts with an open tag <head> and ends with a close tag </head>. A non-frame type html file is composed of a body section in addition to a head section, and a body section starts with an open tag <body> and ends with a close tag </body>. A frame type html file is composed of, in addition to a head section, a frameset element which starts with an open tag <frameset> and ends with a close tag </frameset> which may enclose one or more frame elements and other frameset element or elements.

A website can be simple and made of just one html file or a few html files, or can be complex of comprising a database which stores data and information related to the website. One type of website is directory site: a site that contains varied contents that are divided into categories and subcategories. Here data, information, and contents are inseparable and interchangeable, and they have the same common meanings.

An entity is something that has a distinct, separate existence, though it need not be material existence. In general, there is also no presumption that an entity is animate. An entity could be viewed as a set containing subsets. A set can be thought of as any collection of distinct things considered as a whole. In computer programming, an entity is persistent that means it can be stored in and retrieved from computer-readable medium such as a file system or database in memory or hard disk.

The term “Entity” and the corresponding Entity class, in this disclosure, is used to define the most abstract and topmost superset of all entities. It also implements common methods applicable for all entities.

The term “EntityPresentation” and its corresponding EntityPresentation interface, in this disclosure, is used to define the signatures of a set of common methods of presenting an entity. There are many different ways to present an entity through construction and modification of its html format or other formats. In some situation the content of an entity itself is in html format and can be used directly.

As a subset of Entity, the term “Page” or “page” and its corresponding Page class are used to represent a web page. The representation of a web page does not mean that it is the actual html file of the web page. A page is used as reference during the generation of the html file to pull together all the contents that make up the html file that the page is representing. This process is taken place in PagePresentation class, which implements EntityPresentation interface.

The contents of a non-frame type html file are enclosed in its body section between the open tag <body> and close tag </body>. And frequently contents are presented in an html table element or multiple subsequent html tables. An html table can include other html table or tables and become nested. The html table model allows arranging data—text, preformatted text, images, links, forms, form fields, other tables, etc.—into rows and columns of cells.

An html table starts with an open tag <table> and ends with a close tag </table>, in between there may be a row element or multiple row elements. A row element starts with an open tag <tr> and ends with a close tag </tr>, in between there may be a cell element or multiple cell elements. A cell element starts with an open tag <td> and ends with a close tag </td>, and a piece of content can be enclosed in a cell element.

As another subset of Entity, the term “Mosaic” or “mosaic” and its corresponding Mosaic class are used to represent a piece of content or any meaningful information which makes up a component or part of a web page. A mosaic is used as reference to pull together all the sub contents that make up the piece of content that the mosaic is representing, during the generation of the piece of content. The process is taken place in an instance of MosaicPresentation class that implements EntityPresentation interface. A mosaic can be used to represent any meaningful information either locally or remotely and bound to it. A mosaic can be exposed as a service so another website can use the service and acquire the content the mosaic is representing.

To build up the relationship between a page and a mosaic or mosaics, like playing a tiling puzzle, imagine a page as a billboard and a mosaic as a piece of puzzle, a mosaic or mosaics need to be hanged on that billboard in an orderly way to accomplish a recognizing pattern or presentation of the page. This is where a “MosaicHanger” comes in to play.

MosaicHanger class is defined as a subclass of Entity class and a MosaicHanger is used to connect a mosaic with a page. It uses two variables X and Y to identify the position a mosaic is hanged on a page. X represents the horizontal or row position. Y represents the vertical or column position.

A web page is separated into two major sections: a head section, and a body section in the case of a non-frame html file or a frameset element in the case of a frame type html file. In one embodiment, a mosaic representing proper information for a web page's head section is hanged on or said injected into the head section of a web page when its hanging position's X and Y values are specified as negative values.

In the process of generating the body section of a non-frame type html file represented by a page, all MosaicHangers associated with the page (excluding MosaicHangers hanged on the head section of the page) are sorted out and group into slices. Each slice represents a group of MosaicHanger or MosaicHangers with the same X value. An html table element with only one row is then created, and each cell corresponds to each MosaicHanger in the slice is subsequently created in the row in the order of their Y values. Each MosaicHanger references a mosaic, and the content represented by the mosaic is pulled in to fill the corresponding cell. After one slice is done, then go to the next slice. This process keeps going until all the slices are done.

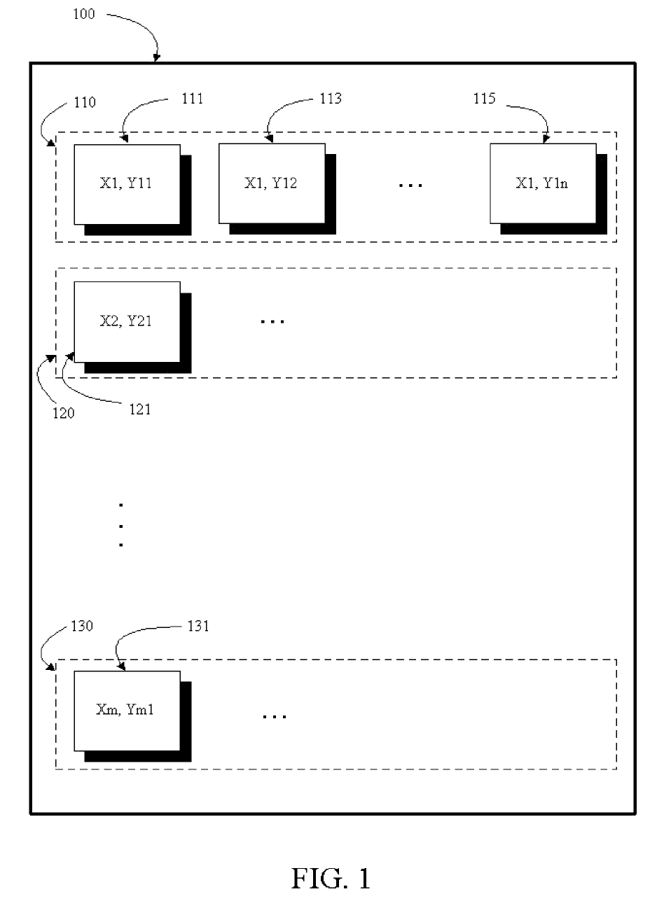

FIG. 1 represents an exemplary embodiment and illustrates a Page 100 and a handful of Mosaics (111, 113, 115, 121, 131) hanged on the Page 100 excluding the head section; Mosaic 111 hanged at a position of X1 and Y1n; Mosaic 113 hanged at a position of X1 and Y12; Mosaic 115 hanged at a position of X1 and Y1n; Mosaic 121 hanged at a position of X2 and Y21; Mosaic 131 hanged at a position of Xm and Ym1. During the generation of the Page 100, Mosaics with same X values are grouped into a slice, and according to their hanging position's X values, Mosaics (111, 113, 115) are grouped into a slice 110, Mosaic 121 into a slice 120, and Mosaic 131 into a slice 130, then an html table with only one row is created to represent each slice and each cell encloses the content represented by each Mosaic in the slice, one by one until all slices are done.

A mosaic can be nested, which means other mosaic or mosaics can be hanged on the mosaic (parent mosaic) in the same way as a mosaic or mosaics hanged on a page as aforementioned. And the level of nested can be any. A MosaicHanger is also used to connect a mosaic and its parent mosaic. It uses the same two variables X and Y to identify the position a mosaic is hanged on its parent mosaic. X represents the horizontal or row position. Y represents the vertical or column position.

In the process of generating a piece of content represented by a nested mosaic, all MosaicHangers associated with the nested mosaic (parent mosaic) are sorted out and group into slices. Each slice represents a group of MosaicHangers with the same X value. An html table element with only one row is then created, and each cell corresponds to each MosaicHanger in the slice is created subsequently in the row in the order of their Y values. Each MosaicHanger references a mosaic, and the content represented by the mosaic is pulled in to fill the corresponding cell. After one slice is done, then go to the next slice. This process keeps going until all the slices are done.

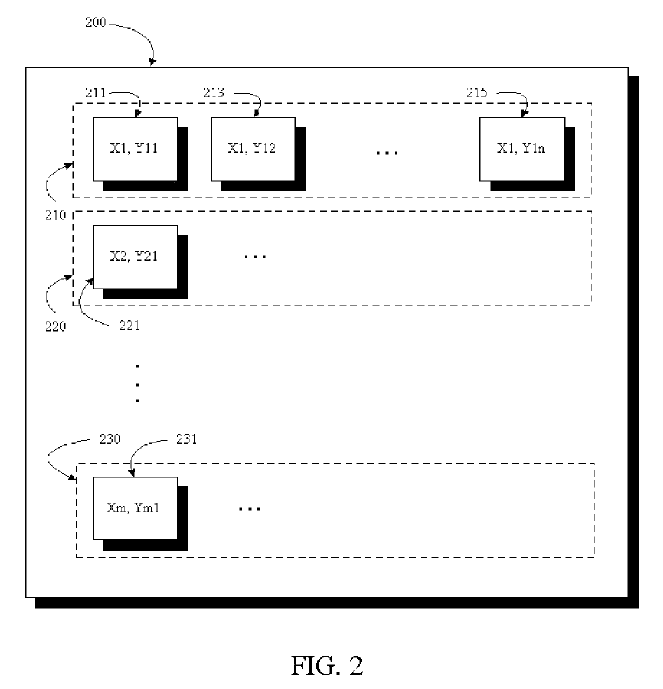

FIG. 2 represents an exemplary embodiment and illustrates a nested Mosaic 200 and a handful of Mosaics (211, 213, 215, 221, 231) hanged on the Mosaic 200; Mosaic 211 hanged at a position of X1 and Y1n; Mosaic 213 hanged at a position of X1 and Y12; Mosaic 215 hanged at a position of X1 and Y1n; Mosaic 221 hanged at a position of X2 and Y21; Mosaic 231 hanged at a position of Xm and Ym1. During the generation of the content of Mosaic 200, Mosaics hanged on Mosaic 200 with same X values are grouped into a slice, and according to their hanging position's X values, Mosaics (211, 213, 215) are grouped into a slice 210, Mosaic 221 into a slice 220, and Mosaic 231 into a slice 230, then an html table with only one row is created to represent each slice and each cell encloses the content represented by each Mosaic in the slice, one by one until all slices are done.

For a simple non-nested mosaic, it can be bound to an instance of an Entity identified by the fully qualified class name of its EntityPresentation implementation class with an identifier identifying the instance of the Entity. MosaicBinder class is defined as a subclass of Entity class and a MosaicBinder is used to handle such relationships. When needed, a MosaicBinder pulls out the content through the EntityPresentation implementation on an instance of the Entity and an identifier identifying the instance of the Entity. A mosaic can be bound to only one instance at a time. To avoid dead loop, a mosaic would not be bound to a Page instance or a Mosaic instance.

Document, music, picture, and video are some often-seen contents. In this disclosure, as different subsets of Entity, the term “Document”, “Music”, “Picture”, and “Video” as well as corresponding Document class, Music class, Picture class, and Video class, are used to represent the collection of the corresponding contents, respectively. The corresponding entity presentation classes are DocumentPresentation, MusicPresentation, PicturePresentation, VideoPresentation, they all implement EntityPresentation interface.

To have a page representing a web page that presents a specific content such as a picture to a user for viewing in a web browser, such a page is a “Specific” type page. For a page to relate to a specific content or instance of an Entity, PageMap class is defined as a subclass of Entity class and a PageMap is used to map a page to an instance of an Entity identified by the fully qualified class name of its EntityPresentation implementation class with an identifier identifying the instance of the Entity, and at the same time, a mosaic, a MosaicBinder, and a MosaicHanger are created; the MosaicBinder binds the mosaic with an instance of an Entity identified by the fully qualified class name of its EntityPresentation implementation class with the identifier identifying the instance of the Entity; the MosaicHanger then hangs the mosaic on the page at a pre-defined position. One exception is: for mapping a page to a mosaic, a PageMap is used to map the page to the mosaic identified by the fully qualified class name of MosaicPresentation class with an identifier identifying the mosaic, and at the same time, no MosaicBinder but only a MosaicHanger is created; the MosaicHanger then hangs the mosaic on the page at a pre-defined position. Second exception is: a page would not be mapped to another page, when a page is created, no PageMap, no mosaic, no MosaicBinder, no MosaicHanger are created.

In one embodiment, during the creation of an instance of Picture, which will be presented in a web page by its underlying html file that is represented by a page, a page is created with a string as the page's identifier; a mosaic, a PageMap, a MosaicBinder, and a MosaicHanger are also created; for simplicity, all use the same string as the page's identifier as their identifiers; the PageMap maps the page to the instance of Picture identified by the fully qualified class name of PicturePresentation class and the instance's identifier; the MosaicBinder binds the mosaic to the instance of Picture identified by the fully qualified class name of PicturePresentation class and the instance's identifier; the MosaicHanger hangs the mosaic on the page at the pre-defined or default position (X=64, Y=64). Here, the creation, mapping, binding, hanging, all means the action of creating a record of the associated information and storing it in the corresponding tables of a database, as specified below:

In one embodiment, a database table named “Page” is used to store the record about a page; a database table named “Mosaic” is used to store the record about a mosaic; a database table named “PageMap” is used to store the record about the relationships of a page with the fully qualified class name of an Entity's EntityPresentation implementation class and an identifier identifying an instance of the Entity; a database table named “MosaicBinder” is used to store the record about the relationships of a mosaic and an instance of an Entity identified by the fully qualified class name of the Entity's EntityPresentation implementation class and an identifier identifying the instance of the Entity; a database table named “MosaicHanger” is used to store the record about the relationships of a mosaic and a page identified by the fully qualified class name of PagePresentation class and an identifier identifying the page, or another mosaic identified by the fully qualified class name of MosaicPresentation class and an identifier identifying the mosaic, as well as the hanging position information of X and Y values. If a page is removed or deleted from the database table “Page”, all the related records existed in the related database tables also need to be removed.

To better manage pages in a structural way similar to a directory tree management style, a page can be defined as either “Specific”, “DirectoryTyped”, “Reference”, or “Directory”, separately; this is the DirectoryType property of a page. In one embodiment, a field or a column named “directorytype” in the database table named “Page” is used to record the four different definitions.

A “Specific” page, as aforementioned, is either a page itself and not mapped to any other entities, or a page mapped to an instance of Mosaic, Document, Picture, Music, or Video, etc. In one embodiment, another field or column named “classname” in the database table named “Page” is used to record the fully qualified class name of the EntityPresentation implementation class of a specific type of content.

A “DirectoryTyped” page is used to hold a group of “Specific” page or pages with the same specific type of content and act as the parent page to hold on to this group of page or pages. It does not allow other type of “Specific” page or pages to join in. In one embodiment, the fully qualified class name of the EntityPresentation implementation class of the specific type of content of the group is recorded in the parent page's “classname” field in the database table named “Page” to reflect this characteristic.

A “Reference” page, as the name implied, is a page pointed to or link to another page, which might reside at the same website, or at a different or remote website. PageReference class is defined as a subclass of Entity and a PageReference is used to handle the relationship between a “Reference” page and the referenced page. A referenced page, if itself were a “Reference” page, can further reference another page.

A “Directory” page is a generic page, which can hold all the pages including another “Directory” page or pages.

PageChild class is defined as a subclass of Entity and a PageChild is used to store the information of parent page and child page relationships.

A mosaic, similar to a page, can be defined as “Specific”, “DirectoryTyped”, “Reference”, or “Directory”, separately. In one embodiment, a field or a column named “directorytype” in a database table named “Mosaic” is used to record the four different definitions.

A “Specific” mosaic is a mosaic representing a piece of content of a specific type such as Document, Music, Picture, or Video excluding Page and Mosaic. The corresponding MosaicBinder binds the mosaic with an Entity's EntityPresentation implementation class with an identifier identifying an instance of the Entity. In one embodiment, a field or column named “classname” in the database table named “Mosaic” is used to record the fully qualified class name of the EntityPresentation implementation class of the specific type of content, and at the same time, a record in the database table named “MosaicBinder”, holds the information of the mosaic with the fully qualified class name of the EntityPresentation implementation class of the specific type of content and an identifier identifying an instance of the specific type of content.

A “DirectoryTyped” mosaic is used as parent mosaic and it can be hanged on by a group of “Specific” mosaic or mosaics bound with the same specific type of content. It does not allow other type of “Specific” mosaic or mosaics to hang on it. In one embodiment, the fully qualified class name of the EntityPresentation implementation class of the specific type of content of the group is recorded in the parent mosaic's “classname” field in the database table named “Mosaic” to reflect this characteristic.

A “Reference” mosaic, as the name implied, is a mosaic pointed to or link to another mosaic, which might reside at the same website, or at a different or remote website. MosaicReference class is defined a subclass of Entity and a MosaicReference is used to handle the relationship between a “Reference” mosaic and the referenced mosaic. A referenced mosaic, if itself were a “Reference” mosaic, can further reference another mosaic.

A “Directory” mosaic is a generic mosaic, which can be hanged on by all the mosaics including another “Directory” mosaic or mosaics.

A MosaicHanger holds the information of a parent mosaic and its child mosaic relationships. In one embodiment, a database table name “MosaicHanger” holds the record of a mosaic as parent mosaic and a child mosaic that is hanged on the parent mosaic at a position specified by the X and Y values.

After defining the directory structure of page, some directory or directory tree related operation or features are specified as below:

When hanging a mosaic on a page, the mosaic can be hanged on the page and all its descendent pages; the mosaic may only be hanged on some of the pages in a directory tree if a filtering condition is set. MosaicHangerOnTree class is defined as a subclass of Entity and a MosaicHangerOnTree is used to take care of this.

In one embodiment, a record in a database table named “MosaicHangerOnTree” holds the information of a mosaic, a top page of a directory tree, a hanging position specified by X and Y values, and the filtering conditions on page's “directorytype” and “classname” the fully qualified class name of an EntityPresentation implementation class that the page mapped or assigned. In one embodiment, when a new page is created, check should be taken to see if there are any new MosaicHangers need to be created to hang on the newly created page, according to whether or not there is any MosaicHangerOnTree on this new page's ancestor or ancestors, and the new page complies with the filtering condition and is not being filtered out. On the other hand, once a MosaicHangerOnTree is deleted, all the MosaicHanger or MosaicHangers related or referenced this MosaicHangerOnTree need to be removed and deleted also.

As a subset of Entity, the term “SearchBox” or “searchbox” and its corresponding SearchBox class is used to define a search criteria on directory tree of pages or entities and output a list of or collection of the entities that complies with the search criteria. By doing that, it represents or provides a search function. The presentation of the search output is handled through SearchBoxPresentation class, an implementation of EntityPresentation interface.

In one embodiment, a record in a database table named “SearchBox” holds the information of a “frompage” which is the top page of a directory tree that is going to be searched, a “depth” which indicates the search level from the top page deep down to the directory tree, a directorytype of page the searchbox is searching for, a fully qualified class name of an Entity's EntityPresentation implementation class which indicates the specific type of content the searchbox is searching for, an “orderby” which indicates the field a search is based upon for the order of the search result, an “ascdesc” which indicates the ascending or descending direction of the order.

SearchPresentation interface is used to define the signature of common method or methods of presenting a sorted list of antities of a search result without the actual implementation. In implementing SearchPresentation, an Entity may have many different ways to present the search output of a searchbox through construction and modification of its html format. A way of presenting a search output of an Entity may be identified by the fully qualified class name of its related class which implemented SearchPresentation. In one embodiment, a record in a database table named “SearchBox” also holds the information of a selected fully qualified class name of an Entity's SearchPresentation implementation.

SearchInterface interface is used to define the signature of common method or methods of providing sorting support, a list of orderby fields, an array list of an Entity's SearchPresentation implementation classes and their titles.

In one embodiment, in the process of generating the output of a searchbox's search inside SearchBoxPresentation, first, it searches out a member list of an Entity according to the searching criteria defined by the searchbox, and second, it hands down the list to the Entity's SearchInterface implementation which provides sorting support and gets back a sorted list according to the sorting criteria defined in the searchbox, and third, it hands down the sorted list to the Entity's SearchPresentation implementation and gets back the presentation result from it. The result is returned as the searchbox's output.

Some useful usages including: when a mosaic bound with a searchbox is hanged on a page or pages in a directory tree, it can be used to provide website navigation functions; it can be also used to present meaningful information such as a group of pictures or a list of documents, and if a link is provided at each picture or document, clicking that link can bring a user down to a specific picture or document.

In one embodiment, a Mosaic is exposed as a service by a custom API (Application Programming Interface) and consumed by other websites to reuse the Mosaic as a component of a web page in a website. A Mosaic is bound to a function of consuming a service exposed by the custom API through a MosaicBinder binding the Mosaic with the function.

In one embodiment, a Mosaic also is exposed as a web service by standardized WSDL (Web Service Description Language) to define a service endpoint and port, and the content represented by the Mosaic is enclosed in the body of a SOAP (Simple Object Access Protocol) message, and the web service is consumed by other websites or software programs for the reuse of the Mosaic, which provides a way of syndication of different websites and software programs on a component level. a Mosaic is bound to a function of consuming a web service exposed by a website's standardized WSDL through a MosaicBinder binding the Mosaic with the function of consuming the web service. If the content represented by the Mosaic is in XML format, and it embedded with a reference link for its extensible style sheet transformation information (XSLT), the function for consuming the web service can implement a transformation and turning the content into html format according to the patterns and rules defined in the XSLT.

When a user sends in a request to request a page, a web application server identifies that the request is requesting a page by identifying the request's URI (Here the URI—Uniform Resource Identifier, in this disclosure, is defined as the part of a request's URL from the protocol name up to the query string in the first line of the HTTP request), and subsequently the requested page is identified in the parameter list; the web application server then responses with either a pre-generated static html file or a dynamically generated html file which is represented by the page. In one embodiment, the URI for requesting a page is defined and identified as “/servlet/Page”, there is an underlying action class to do the actual work to fullfil the request and return a response, here the action class for “/servlet/Page” is PageServlet class, a Java class running in a web application server on a Java Virtual Machine.

In addition to handling a page request, a website may provide many other function and interaction to a user, such as logon, logoff, etc.; Each might represent a different request URI. In general, they all involve sending out a response upon receiving a request. The presentation of a response is a common behaviour involved.

Thus, ServletPresentation interface is used to define the signature of common method of generating the presentation of a response on a request. Under each different request URI, if it is not resorted to a static resource, there is an underlying action class to do the actual work to fullfil the request and return a response, the action class would implement the ServletPresentation interface. In one embodiment, PageServlet implements ServletPresentation.

A mosaic can be bound to a ServletPresentation's implementation class to represent the output of an instance of the ServletPresentation's implementation class. Such a relationship is handled by a MosaicBinder with both the “identifier” field and “classname” field identifying the fully qualified name of the ServletPresentation implementation class and a “mosaic” field identifying a mosaic.

A mosaic can also be hanged on a request URI's action class which implements ServletPresentation. This will provide some meaningful usages to the response's presentation, such as adding some embedding hint, help note, or navigation links, etc. to the surrounding of the action class's presentation; these hanged mosaics can be dynamically configured, changed, or re-arranged without affecting the main body of the action class's presentation. A MosaicHanger is used to handle the relationships of how a mosaic is hanged on a request URI's action class which implements ServletPresentation. It uses two variables X and Y to identify the position a mosaic is hanged on a request URI's action class. X represents the horizontal or row position. Y represents the vertical or column position. In one embodiment, a record in a database table named “MosaicHanger” holds the information of a mosaic, an “identifier” identifying the fully qualified class name of a request URI's action class, a “classname” identifying the fully qualified class name of a request URI's action class, a “X” identifying the hanging horizontal or row position, a “Y” identifying the hanging vertical or column position; since a request URI's action class does not behave like an Entity which an instance can be identified by an identifier, both fields of “identifier” and “classname” holds the fully qualified class name of a request URI's action class, to differentiate them from the rest of the MosaicHangers. In one embodiment, when the hanging position's X and Y values are negative, it means a mosaic associated the MosaicHanger is hanged on the head section of a request URI's action class.

Except the head section, the handling of finding and sorting of MosaicHangers on a request URI's action class which implements ServletPresentation is a little bit different from a Page. ClassLayout class is defined and a ClassLayout is used to define a rectangle area identified by four variables: minimumX, miminumY, maximumX, and maximumY on a response's presentation. The output of a request URI's action class which implements ServletPresentation interface, is enclosed in the rectangle area, and together with other surrounding MosaicHangers if there are any, to make up the whole response's presentation. The minimumX specifies the minimum horizontal or row position, the minimumY specifies the minimum vertical or column position, the maximumX specifies the maximum horizontal or row position, the maximumY specifies the maximum vertical or column position, which all four together make up a rectangle area to hold the output of a request URI's action class which implements ServletPresentation interface.

In the process of generating the body section of a response which is a non-frame type html file upon a request, all MosaicHangers associated with the fully qualified class name of the request URI's action class which implements ServletPresentation (excluding MosaicHangers hanged on the head section) are sorted out and filtering out according to a rectangle area defined by four variables minimumX, minimumY, maximumX, maximumY if there are any, otherwise all MosaicHangers are excluded; those MosaicHangers located in the rectangle area are filtered out. Those above or below the rectangle area are grouped into slices. Each slice represents a group of MosaicHanger or MosaicHangers with the same X value. An html table element with only one row is then created, and each cell corresponding to each MosaicHanger in the slice is created subsequently in the row in the order of their Y values. Each MosaicHanger references a mosaic and the content represented by the mosaic is pulled in to fill the corresponding cell. After one slice is done, then go to the next slice. Those on the leftside and rightside of the rectangle area, together with the rectangle area, groups into a slice, An html table element with only one row and three cells is then created with the first cell holds the leftside area, second cell holds the rectangle area, and the third cell holds the rightside area. If there are more than one MosaicHanger in leftside, then group them into slices; each slice represents a group of MosaicHanger or MosaicHangers with the same X value; an html table element with only one row is then created, and each cell corresponding to each MosaicHanger in the slice is created subsequently in the row in the order of their Y values; each MosaicHanger references a mosaic and the content represented by the mosaic is pulled in to fill the corresponding cell; after one slice is done, then go to the next slice. If there are more than one MosaicHanger in rightside, then do the same as leftside. The process keeps going until all the slices are done.

The whole content of a response can be generated piece by piece and saved in a buffer in proper sequence, upon completion, the whole content as one piece is then sent out to the requesting user's web browser. In another way, response can be sent out to a user's web brower streamingly piece by piece during the generation of the response and there is no need to wait for the whole content to be generated, but every piece has to be in the right position of a sequence to be sent out otherwise the appearance in the user's web browse will mix up. The whole process can be executed in one thread step by step serially or in a multi-thread environment parallelly. Generally a multi-thread execution will perform faster but does need extra computing resources for coordination and synchronization. In streaming, a piece of content may be saved to a buffer right the way when it is generated or it has to wait for its turn until a notification is received. The order of the contents and content sending out are handled through a buffer.

Multiple mosaics are hanged on a page or a request URI's action class which implements ServletPresentation (excluding mosaics hanged on the head section), in an orderly way, from left to right and from top to bottom, according to the X and Y values holded in the corresponding MosaicHangers. Each individual mosaic can be processed by a thread individually when fetching its corresponding content which is represented by or bound with the mosaic. Each mosaic is deployed with a thread to handle its content fetching. All threads working together parallely to generate a quick response upon a request. In the situation of a nested mosaic, each mosaic hanged on the nested mosaic is deployed with a new thread to handle its content fetching individually. All threads work together parallelly to put together all the sub contents of child mosaics hanged on this nested mosaic.

To organize multiple threads and provide a structure for programming, six types of thread classes are defined: FeaMatrix, FeaSlice, FeaLattice, FeaMosaicHanger, FeaMosaic, and FeaBox:

A FeaMatrix thread represents the top thread of handling a page, a request URI's action class, a nested mosaic, or a group of MosaicHangers. A thread in charge of generating a response upon receiving a request, or in charge of generating the content represented by a nested mosaic, spawns a FeaMatrix thread and pass into the FeaMatrix thread a collection of all the found MosaicHangers on a page or on a request URI's action class (excluding mosaics hanged on the head section), or on a nested mosaic, respectively. Generally, when facing a group of MosaicHangers, a thread spawns a FeaMatrix thread to handle the generation of contents represented by the group of MosaicHangers.

A FeaSlice thread is used to handle each of the slice grouped with the same X value of MosaicHangers, it will be spawned by a FeaMatrix thread which handles the sorting and grouping of MosaicHangers on a page, a request URI's action class, or a nested mosaic, respectively. A FeaMatrix spawns none or at least one FeaSlice thread.

A FeaLattice thread is used to handle each of the cell in the one-row html table of a slice in addition to a FeaLattice thread for handling the beginning or head of the one-row html table. Each cell holds a corresponding MosaicHanger. A FeaLattice thread is spawned by a FeaSlice thread which handles the slice. A FeaSlice spawns at least two or more FeaLattice threads.

A FeaMosaicHanger thread is used to handle a MosaicHanger, to find out if the mosaic associated the MosaicHanger is a nested mosaic or not, if the mosaic is a nested mosaic, then the FeaMosaicHanger thread spawns a new FeaMatrix thread and pass in all the found MosaicHangers hanged on this nested mosaic; if not a nested mosaic, the FeaMosaicHanger thread spawns a new FeaMosaic thread. Except the FeaLattice thread which handles the beginning or head of the one-row html table, a FeaMosaicHanger is spawned by a FeaLattice thread which handles the cell that encloses the MosaicHanger. A FeaLattice can only spawn one FeaMosaicHanger thread.

A FeaMosaic thread is used to fetch the content which is represented by a mosaic. A FeaMosaic thread is spawned by a FeaMosaicHanger thread which handles the MosaicHanger which is associated with a mosaic. A FeaMosaicHange can only spawn one FeaMosaic thread.

A FeaBox thread is used in the situation of a slice involving a rectangle area and the slice representing an one-row html table which includes three cells: leftside cell, rectangle area cell, and rightside cell. A FeaBox thread is used to represent the enclosed content in each of the three cells. Except the FeaLattice thread which handles the beginning or head of the one-row html table, each FeaLattice thread spawns a FeaBox thread for each of the three cells instead of spawing a FeaMosaicHanger. A FeaLattice can only spawn one FeaBox thread. If either one of the three cells contain at least one MosaicHanger, its FeaBox thread will spawn a new FeaMatrix thread to handle those MosaicHangers.

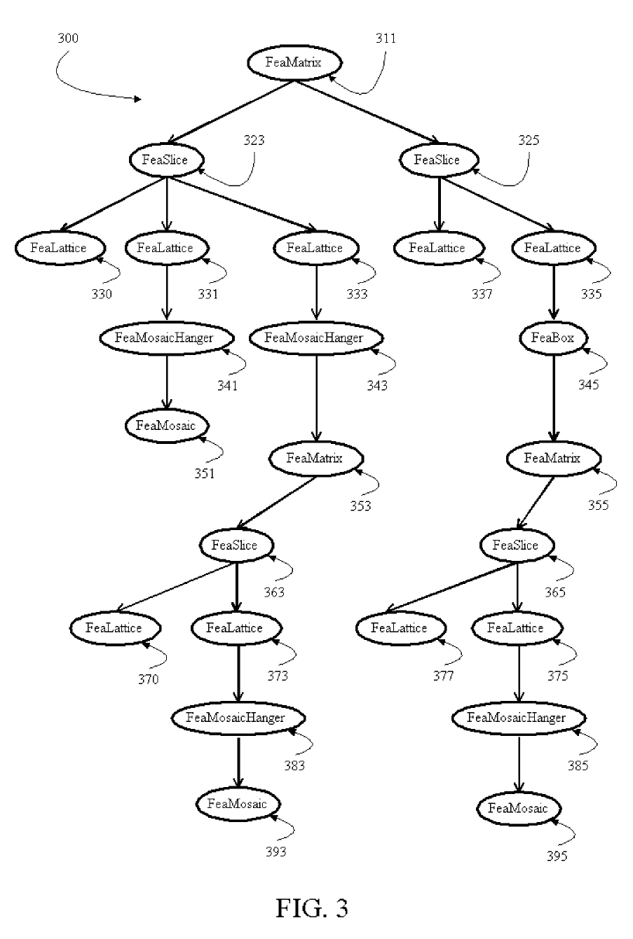

FIG. 3 represents an exemplary embodiment and illustrates an hierarchy of threads 300 and its spawing process. FeaMatrix thread 311 is the topmost thread of the hierarchy which is spawned by a thread in charge of generating a response upon receiving a request, it spawns FeaSlice thread 323 and FeaSlice thread 325; FeaSlice thread 323 represents a group of MosaicHangers with the same X values of horizontal or row hanging position, it spawns FeaLattice thread 330 for handling the beginning or head of the one-row only html table associated with FeaSlice thread 323, FeaLattice thread 331 and FeaLattice thread 333 for a MosaicHanger in a cell in the html table respectively; FeaLattice thread 331 spawns FeaMosaicHanger thread 341 and subsequently FeaMosaicHanger thread 341 spawns FeaMosaic thread 351 to fetch the content represented by a Mosaic which FeaMosaic 351 is associated with; FeaLattice thread 333 spawns FeaMosaicHanger thread 343 and subsequently FeaMosaicHanger thread 343 spawns FeaMatrix thread 353 which indicates that the Mosaic which FeaMosaicHanger thread 343 is associated with is a nested Mosaic, and a collection of MosaicHangers found hanged on the nested Mosaic is passed into FeaMatrix thread 353 for further processing; FeaMatrix thread 353 spawns FeaSlice thread 363; FeaSlice thread 363 spawns FeaLattice thread 370 for handling the beginning or head of the one-row only html table associated with FeaSlice thread 363, and FeaLattice thread 373 which subsequently spawns FeaMosaicHanger thread 383 which subsequently spawns FeaMosaic thread 393; FeaSlice thread 325 is associated with a slice involving a rectangle area and the slice representing an one-row only html table which includes three cells: leftside cell, rectangle area cell, and rightside cell; FeaSlice thread 325 spawns FeaLattice thread 337 for handling the beginning or head of the one-row only html table associated with FeaSlice thread 325, and FeaLattice thread 335 for handling one of the three cells in the html table; FeaLattice thread 335 spawns FeaBox thread 345 and subsequently FeaBox thread 345 spawns FeaMatrix thread 355 and a collection of MosaicHangers associated with FeaBox thread 345 is passed into FeaMatrix thread 355 for further processing; FeaMatrix thread 355 spawns FeaSlice thread 365; FeaSlice thread 365 spawns FeaLattice thread 377 for handling the beginning or head of the one-row only html table associated with FeaSlice thread 365, and FeaLattice thread 375 which subsequently spawns FeaMosaicHanger thread 385 which subsequently spawns FeaMosaic thread 395.

Some threads will probably run fast and accomplish its task quicker than other threads that might face complex and time-consuming tasks, and it is most likely not their turn yet to save the generated content into a buffer. However the content has to be saved in an orderly sequence in a buffer and sent to a user's web browser to appear properly, so the finished thread has to wait for a signal or a flag before the generated content can be placed into a buffer. Once a thread receives the signal or flag indicating that now it is its turn to place the generated content in the buffer, it should proceed to do that, and at the same time, it should set or turn on the signal or flag of the next thread in sequence and notify all threads that it is done. Here is how a “FeaFlag” comes to play.

FeaFlag class is defined and an instance of FeaFlag is composed of a Boolean field and an array of instances of FeaFlag class itself. If the Boolean field is true, then it means a thread associated with the FeaFlag instance can save its generated content now into a buffer. The default value of the Boolean field is false. The fact that an instance of FeaFlag has an Array of instances of FeaFlag makes it a nested structure. The nested level is not limited.

Upon the creation of a new FeaMatrix thread, the creating thread will instantiate two instances of FeaFlag and pass them into the newly created FeaMatrix thread. In one embodiment, one FeaFlag instance is named “matrixFlag” and another FeaFlag instance is named “matrixFlagEnd”. The creating thread also pass in a collection of the found related MosaicHanger or MosaicHangers for the FeaMatrix thread to sort and group them into slices according to their X values, and arrange their orders in a slice according to their Y values. Upon the completion of sorting and grouping, an array of FeaFlag instances named “sliceFlag” with the size equals to the number of slices is instantiated, with each FeaFlag instance (sliceFlag[index1]) corresponds to a slice, here index1 starts from 0. The array sliceFlag is set as the matrixFlag's array of FeaFlag instances; at the same time, an array of FeaFlag instances named “latticeFlag” with the size equals to the number of MosaicHangers in a slice plus one for the beginning or head of an one-row html table, is also instantiated, with the first FeaFlag instance (latticeFlag[0]) corresponds to the beginning or head of an one-row html table and the rest of each FeaFlag instance (latticeFlag[index2]) corresponds to a cell in the slice, and the array latticeFlag is set as the slice's FeaFlag instance (sliceFlag[index1])'s array of FeaFlag instances, until all the slices are done.

A sequence of FeaFlag instances is derived from the structure with each FeaFlag instance corresponds to a thread with the exception of matrixFlagEnd, described as below:

matrixFlag,
sliceFlag[0],
latticeFlag0[0], latticeFlag0[1], ..., latticeFlag0[n0],
sliceFlag[1],
latticeFlag1[0], latticeFlag1[1], ..., latticeFlag1[n1],
...
sliceFlag[m],
latticeFlagm[0], latticeFlagm[1], ..., latticeFlagm[nm],
matrixFlagEnd.

A chain of signaling process can be enacted by turning each FeaFlag instance's Boolean field value into true with each one turning the next one, starting from matrixFlag, sliceFlag[0], and latticeFlag0[0] as one unit, then latticeFlag0[1], . . . , until the last latticeFlag0[n0]; and then sliceFlag[1] and latticeFlag1[0] as one unit, then latticeFlag1[1], . . . , until the last latticeFlag1[n1]; . . . ; and then sliceFlag[m] and latticeFlagm[0] as one unit, then latticeFlagm[1], . . . , until the last latticeFlagm[nm]; and then matrixFlagEnd. The matrixFlag marks the starting point or entry point of the chain and the matrixFlagEnd marks the ending point or exit point of the chain. Here “as one unit” means their Boolean field values are set to true at the same time and treated as one unit or one step.

The matrixFlag marks the starting point or entry point of a FeaMatrix thread that is spawned by a creating thread; the FeaMatrix thread subsequently spawns none or multiple FeaSlice threads which corresponds to each sliceFlag[index1]; each FeaSlice thread subsequently spawns at least two or more FeaLattice threads which corresponds to each latticeFlag[index2]; each FeaLattice thread subsequently spawns either a FeaMosaicHanger thread or a FeaBox thread; in the case of a FeaMosaicHanger thread, a FeaMosaicHanger thread subsequently spawns either a FeaMosaic thread or a new sub FeaMatrix thread; in the case of a FeaBox thread, a FeaBox thread subsequently spawns a new sub FeaMatrix thread. At the end, the matrixFlagEnd marks the ending point or exit point of the FeaMatrix thread. If the Boolean field in matrixFlagEnd is true, that means all threads in this hierarchy (including all new sub FeaMatrix threads which represents a branch of the hierarchy of threads and their descendent threads, if any) are done, if the creating thread is waiting for this, then it can proceed to next step now.

Since a FeaMosaicHanger thread or a FeaBox thread to its creating FeaLattice thread is one-on-one relationship, it shares and uses the creating FeaLattice thread's latticeFlag[index2].

On the creation of a new sub FeaMatrix thread by either a FeaMosaicHanger thread or a FeaBox thread, two instances of FeaFlag are instantiated and passed into the newly created FeaMatrix thread. In one embodiment, one FeaFlag instance is named “subMatrixFlag” which marks the starting point or entry point of the sub FeaMatrix, and the other FeaFlag instance is named “subMatrixFlagEnd” which marks the ending point or exit point of the sub FeaMatrix. The subMatrixFlag is assigned the latticeFlag[index2] of the FeaLattice thread, which is the creating thread of either the FeaMosaicHanger thread or the FeaBox thread and which subsequently is the creating thread of the sub FeaMatrix thread. When the Boolean field of the latticeFlag[index2] is turned into true, the Boolean field of the subMatrixFlag also becomes true. The FeaMosaicHanger thread or the FeaBox thread, which creates the sub FeaMatrix thread, is responsible for signaling the sub FeaMatrix thread through the first element (subSliceFlag[0]) of the subMatrixFlag's subSliceFlag[ ] array and the first element (subLatticeFlag[0]) of the subSliceFlag[0]'s subLatticeFlag[ ] array, and set the value of each element (subSliceFlag[0] and subLatticeFlag[0])'s Boolean field to true. The notification of “true” value on the Boolean field of the subMatrixFlagEnd marks the ending of the sub FeaMatrix thread and all its descendent threads, and the last one thread (associated with the last element of the subLatticeFlag[ ] of the last element of subSliceFlag[ ] of the subMatrixFlag) is responsible for signaling the next thread in the upper level or signaling and setting the value of the Boolean field of the matrixFlagEnd to true if this is also the last element in the upper level.

A common and shared object is used for multiple threads' synchronization in a hierarchy of threads. In one embodiment, an object named “_oSync” is used as a synchronizing object for all the threads of a response generating process in a multi-thread execution environment, a thread sends out a notification by executing a block of program

synchronized(_oSync) {
_oSync.notifyAll( );
}

and wait to receives a notification by executing another block of program

synchronized (_oSync) {
_oSync.wait(timeout);
}

the timeout represents the maximum duration the thread waits, if exceeded, the thread will break out no matter what.

Upon creation of a FeaMatrix thread, the creating thread will wait for the created FeaMatrix thread getting the sorting done and notifying back before it can be able to start or entry the signaling chain, it also need to wait for its turn for signaling if the FeaMatrix thread it created is not the very first one or the top one of a thread hierarchy but rather at a sub level. In one embodiment, the created FeaMatrix thread itself is used as another synchronizing object and has one Boolean field to indicate whether or not the sorting is done, once the sorting is done, it sets the Boolean field value to true and sends out notification by executing a block of program

synchronized(this) {
this.notify( );
}

to the creating thread which is waiting on it, upon being notified and verifying the sorting is done, the creating thread will break out of waiting and proceed to next step.

On generating a response upon a request, in a one-thread execution environment, the task is pretty straight forward: the execution thread sends out the content piece by piece serially whenever a piece is generated and ready to go as the thread proceeds; Typical implementation uses a PrintWriter to print a piece of content or object and invokes a flush( ) method to ask the underlying outputstream to send out the data in a Java programming language environment. Here the outputstream may be used as a temporary buffered area for the output data stream. The other way is to save all the pieces together in a buffer and send it all out as one piece, but the sequence of the pieces does need to be maintained properly in the buffer.

In an execution environment of a hierarchy of threads synchronized with a signaling chain, a buffer area for content line up is used to handle the storage and sending out of the contents generated by each thread. The sequence of the contents in the buffer is properly maintained through a chain of signaling process, each thread waits for its turn to place its generated content in the buffer. The whole group of threads are synchronized and work like a thread, or said a virtual thread. Upon its creation, a buffer area is ready for storage but might not be able to flush and send out contents to a user's web browser just yet since some pre-processing tasks such as preparing a response's header section do need some time to finish, so an object as a key with a boolean value is used as a flag (the “begin flag”) to mark that when the buffer can begin sending out contents. Once the begin flag is turned to true, the same time a thread places a piece of content into the buffer, the content together with whatever currently resides in the buffer can be flushed and sent out to the user immediately. After all threads in the hierarchy have done their jobs, the same key with another boolean value is used as a flag (the “end flag”) to mark the end of execution of all threads in the hierarchy. If one of the thread in the hierarchy spawns a new thread or threads which are out of reach of the signaling chain, the order or sequence of the contents generated from the new thread or threads can not be maintained properly with the group. The new thread then needs a new buffer and a new key with two flags to coordinate and synchronize its content generating process with its creating thread. The details are explained as follow:

An object array (key[ ]) is used as an array of keys or key chain to reflect a series of threads' spawning process and a series of buffers which is associated with a hierarchy of buffers. A buffer in the hierarchy of buffers is associated with a thread, a virtual thread, or a long running method, with each element in the object array as a key which is associated with two flags that one flag (the begin flag) is used to indicate that contents saved and saving into this buffer can be moved into an upper level buffer immediately and in the case of the top most buffer, contents saved and saving into the buffer can be sent out to a user's web browser immediately; anthor flag (the end flag) is used to mark the end of the execution of a thread, a virtual thread, or a long-running method, and the buffer can be removed from the hierarchy.

There are two common methods involved: The first method is used by each thread or a long-running method to save a piece of generated content into its corresponding buffer in the buffer hierarchy, and if indicated by a begin flag that the newly generated content together with previously saved contents can be moved into an upper level buffer, then proceeds to do so; The second method is used by each thread or a long-running method to call on its corresponding buffer in the buffer hierarchy to move all the contents saved in the buffer into an upper level buffer if a begin flag indicates that to do so is allowed otherwise the method will wait until the begin flag is turned on or true, after all the contents saved in the buffer are moved into an upper level buffer, the buffer can be removed, the method then turns the end flag into on or true and notify other thread or threads waiting for that. Detailed explanation as follow:

Starting from the very first element key[0] in an object array (key[ ]) with only one element, which is associated with the top most thread thread0, a buffer buffer0 is used to sequencely store the contents generated from thread0 and its descendent threads. key[0] and a begin flag (a boolean value) are stored in a memory block to indicate whether or not it is thread0's turn to move the contents into an upper lever or in this case send out to a user's web browser. When the boolean value turns to true, a piece of content which is being saved into buffer0 together with whatever contents currently still reside in buffer0 can immediately be moved into an upper level or in this case sending out to a user's web browser. key[0] and an end flag (another boolean value) are stored in another memory block to indicate whether or not thread0 and its descendent threads are done.

If thread0 spawns a new thread thread01, a new object array (key01[ ]) with two elements is generated with the first element (key01[0]) copied from thread0's key[0] element and a newly generated object as the second element (key01[1]). A new buffer buffer01 is created to sequencely store the contents generated from thread01 and its descendent threads. key01[1] and its begin flag are stored in a memory block to indicate whether or not the saved or saving contents in buffer01 can be moved into the upper level buffer buffer0. key01[1] and its end flag are stored in another memory block to indicate whether or not thread01 and its descendent threads are done.

If thread0 spawns another new thread thread02, a new object array (key02[ ]) with two elements is generated with the first element (key02[0]) copied from thread0's key[0] element and a newly generated object as the second element (key02[1]). A new buffer buffer02 is created to sequencely store the contents generated from thread02 and its descendent threads. key02[1] and its begin flag are stored in a memory block to indicate whether or not the saved or saving contents in buffer02 can be moved into the upper level buffer buffer0. key02[1] and its end flag are stored in another memory block to indicate whether or not thread02 and its descendent threads are done.

If thread0 invokes a long-running method method03 in its execution, a new object array (key03[ ]) with two elements is generated with the first element (key03[0]) copied from thread0's key[0] element and a newly generated object as the second element (key03[1]). A new buffer buffer03 is created to sequencely store the contents generated from method03. key03[1] and its begin flag are stored in a memory block to indicate whether or not the saved or saving contents in buffer03 can be moved into the upper level buffer buffer0. key03[1] and its end flag are stored in another memory block to indicate whether or not the long-running method is done;

If inside the long-running method method03, another long-running method method31 is invoked, a new object array (key31[ ]) with three elements is generated with the first two elements (key31[0] and key31[1]) copied from method03's object array (key03[0] and key03[1] respectively) and a newly generated object as the third element (ke31[2]). A new buffer buffer31 is created to sequencely store the contents generated from method31 and its nested long-running methods. key31[2] and its begin flag are stored in a memory block to indicate whether or not the saved or saving contents in buffer31 can be moved into the upper level buffer buffer03. key31[2] and its end flag are stored in another memory block to indicate whether or not method31 and its nested long-running methods are done.

If inside the long-running method method03, a new thread thread32 is invoked, a new object array (key32[ ]) with three elements is generated with the first two elements (key32[0] and key32[1]) copied from method03's object array (key03[0] and key03[1] respectively) and a newly generated object as the third element (ke32[2]). A new buffer buffer32 is created to sequencely store the contents generated from thread32 and its descendent threads. key32[2] and its begin flag are stored in a memory block to indicate whether or not the saved or saving contents in buffer32 can be moved into the upper level buffer buffer03. key32[2] and its end flag are stored in another memory block to indicate whether or not thread32 and its descendent threads are done.

If thread01 spawns a new thread thread11, a new object array (key11[ ]) with three elements is generated with the first two elements (key11[0] and key11[1]) copied from thread01's object array (key01[0] and key01[1] respectively) and a newly generated object as the third element (key11[2]). A new buffer buffer11 is created to sequencely store the contents generated from thread11 and its descendent threads and its long-running methods. key11[2] and its begin flag are stored in a memory block to indicate whether or not the saved or saving contents in buffer11 can be moved into the upper level buffer buffer01. key11[2] and its end flag are stored in another memory block to indicate whether or not thread11 and its descendent threads and its long-running methods are done.

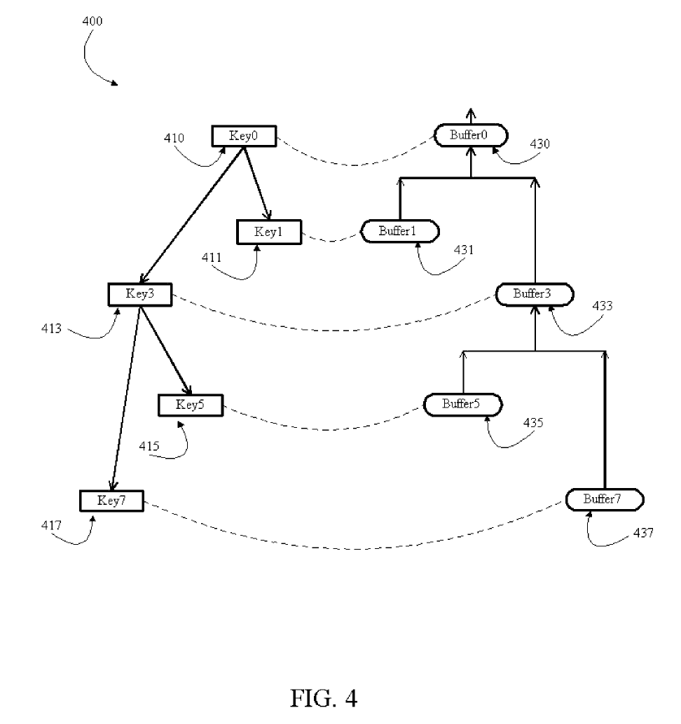

FIG. 4 is an exemplary embodiment of a hierarchy of buffers 400 with the associated keys showing side by side. Buffer 430 associated with key 410 is the top most buffer in the hierarchy of buffers, contents saved in buffer 430 are sent out to a user's browser directly; buffer 431 associated with key 411 is a sub buffer under buffer 430, contents saved in or being saved into buffer 431 are moved into buffer 430 immediately when it is its turn; buffer 433 associated with key 413 is a sub buffer under buffer 430, contents saved in or being saved into buffer 433 are moved into buffer 430 immediately when it is its turn; buffer 435 associated with key 415 is a sub buffer under buffer 433, contents saved in or being saved into buffer 435 are moved into buffer 433 immediately when it is its turn; buffer 437 associated with key 417 is a sub buffer under buffer 433, contents saved in or being saved into buffer 437 are moved into buffer 433 immediately when it is its turn.

In one embodiment, a Java programming language class ServletProcessor is defined. A Hashtable named “beginHashtable” as an instance variable of the ServletProcessor class is used to store a key and its begin flag value, here a FeaFlag instance is used as a begin flag; Another Hashtable named “endHashtable” as another instance variable of the ServletProcessor class is used to store a key and its end flag value, here another FeaFlag instance is used as an end flag; Yet another Hashtable named “printHashtable” as another instance variable of the ServletProcessor class is used to store a key and its corresponding buffer, here a Vector is used as a buffer to store contents, a piece of content can be added to a Vector as its element and other pieces of contents can be subsequently added to the Vector accordingly, elements of a Vector can be cleared out and moved into or added to another Vector; The object named “_oSync” as an instance variable of the ServletProcessor class is used as a common and shared object for synchronization of all the descendent threads and long-running methods spawned from the current thread which instantiates an instance of ServletProcessor class.

The two common methods are implemented as public instance methods in the ServletProcessor class:

The first method: print(Object key[ ], Object obj) is used by a thread or a long-running method to save a piece of content (represented by “obj”) into its corresponding buffer in a hierarchy of buffers; a buffer is identified by the last element of the object array key[ ] as a key in the printHashtable, and the begin flag is identified by the same key in the beginHashtable. The upper level buffer is identified by the second to last element of the object array key[ ] as a key in the printHashtable.

The second method: printed(Object key[ ]) is used by a thread or a long-running method to call on its corresponding buffer in a hierarchy of buffers to move all the contents saved in the buffer into an upper level buffer if a begin flag indicates that to do so is allowed, otherwise the method will wait on the synchronizing object _oSync until the begin flag is turned on or true, after all the contents saved in the buffer are moved into an upper level buffer, the buffer can be removed, the method then turns the end flag into true and notify other thread or threads by _oSync.notifyAll( ) method. The buffer is identified by the last element of the object array key[ ] as a key in the printHashtable, and the begin flag and end flag are identified separately by the same key in the beginHashtable and endHashtable respectively. The upper level buffer is identified by the second to last element of the object array key[ ] as a key in the printHashtable.

In one embodiment, a hierarchy of threads synchronized with a signaling chain, starts from a top most FeaMatrix thread which is passed in an object array printid[ ] with only one element printid[0]. The printid[0] serves as a key to identify a buffer in the printHashtable. The key's begin flag in the beginHashtable is set to true when some pre-processing tasks such as preparing a response's header section is done in the creating thread which creates the top most FeaMatrix thread. The object array printid[ ] subsequently is passed down to the FeaMatrix thread's descendent threads without modification: FeaSlice thread(s), FeaLattice thread(s), FeaBox threads(s), and FeaMosaicHanger thread(s), and sub FeaMatrix thread(s) if any. Each thread waits for its turn on the signaling chain and then save a piece of generated content to the buffer by executing the print(Object key[ ], Object obj) method, here object array printid[ ] is the key[ ] and the obj is the generated content need to be saved. A FeaMosaicHanger may subsequently spawn a FeaMosaic thread which is out of the reach of the signaling chain and the sequence of its generated content in the whole response generating process can not be properly maintained; so for FeaMosaic thread as well as a long-running method, a new object array is generated with the first element copied from printid[0] and a newly generated object as the second element which is associated with a new buffer, a begin flag, and an end flag. Through this, the construction and delivery of a response in proper sequence is well organized and synchronized.

Cascading Style Sheets (CSS) is a simple mechanism for adding style (e.g. fonts, colors, spacing) to html files. Styles sheets define how html elements are to be displayed. Style sheets allow style information to be specified in many ways. Styles can be specified inside a single html element (inline style), inside the <head> element of an html file (internal style sheet), or in an external CSS file. Multiple external style sheets can be referenced inside a single html file. Each html element in an html file is identified by a unique ID, an external CSS file stores the ID and its related style sheets information.

When a mosaic or multiple mosaics are hanged on a page, they are grouped into slices according to their MosaicHanger's X values (excluding mosaics hanged on the head section if any). An html table with only one row is then created to enclose a slice with each cell corresponding to each mosaic's MosaicHanger in the slice according to the order of their Y values. The html table can be identified and specified with a tableID, the row can be identified and specified with a rowID, and each cell can be identified and specified by its cellID. Style sheets information related to each ID can then be stored in a database table or an external CSS file for later reference.

Each html table can be uniquely differentiated from other html tables by the X value of the corresponding slice, here the X value is treated as a “tableIndex”; the row element in the html table can be identified by adding a row factor or a “rowIndex”; then each of the cell elements in the row can be identified by adding a cell factor of each cell's index information in the row, or say a “cellIndex”; and finally, a page's identifier can be used as prefix to make an element's ID (tableID, rowID, cellID) globally unique.

In one embodiment, a html table's tableID is the concatenation of a page's identifier, the X value of a slice associated with the html table as tableIndex, a string “0” representing rowIndex, and a string “0” representing cellIndex; the rowID of the only row in the html table is the concatenation of the page's identifier, the same X value of a slice associated with the html table as tableIndex, a string “1” representing rowIndex, and a string “0” representing cellIndex; the first cell's cellID is the concatenation of the page's identifier, the same X value of a slice associated with the html table as tableIndex, a string “1” representing rowIndex, and a string “1” representing cellIndex; the second cell's cellID is the concatenation of the page's identifier, the same X value of a slice associated with the html table as tableIndex, a string “1” representing rowIndex, and a string “2” representing cellIndex; and subsequent cell's cellID can be made up of by increment of the cellIndex.

In the case of a mosaic or mosaics hanged on a mosaic (parent mosaic), the parent mosaic's identifier is used as the prefix to substitute a page's identifier for making up an element's ID (tableID, rowID, cellID); In the case of a mosaic or mosaics hanged on a request URI's action class, the name of the action class is used as the prefix to substitute a page's identifier for making up an element's ID (tableID, rowID, cellID).

In one embodiment, a record in a database table named “CssElement” holds the information of a page's identifier, the fully qualified class name of PagePresentation class, a tableIndex, a rowIndex, a cellIndex, and style sheets information, the record identifies a CSS element (tableID, rowID, or cellID) on a page; another record in the same database table holds the information of a mosaic's identifier, the fully qualified class name of MosaicPresentation class, a tableIndex, a rowIndex, a cellIndex, and style sheets information, the record identifies a CSS element (tableID, rowID, or cellID) on the mosaic; yet another record in the same database table holds the information of the fully qualified class name of a request URI's action class, a tableIndex, a rowIndex, a cellIndex, and style sheets information, the record identifies a CSS element (tableID, rowID, or cellID) on the request URI's action class.

In one embodiment, a ManageCss class is used to display all the top level CSS elements (not including nested CSS elements) on a page, a nested mosaic, or a request URI's action class, so an author can get into a specific CSS element to edit its style sheets information in another class ManageCssElement, and then store the record in the “CssElement” database table. All tableIndex, rowIndex, and cellIndex information are retrieved from an instance of a helper class FeaHelper stored in a session. After a FeaMatrix thread has sorted out all MosaicHangers on a page, a nested mosaic, or a request URI's action class, it instantiates an instance of FeaHelper class and sets in the tableIndex, rowIndex, and cellIndex information into the FeaHelper instance and stores it in a session for the later retrieval.

A page, a mosaic, or a request URI's action class, all has a corresponding external CSS file to store the style sheets information of its top level CSS elements (tableID, rowID, cellID). Further, a nested mosaic's external CSS file also includes the style sheets information of all the descendent mosaics' CSS elements. If the style sheets information of a mosaic's CSS element is changed, then all the external CSS files of the mosaic's ancestors are also updated. This will make an html file's job to reference its external CSS files much easy since all the descendent mosaics' style sheets information has been accumulated in the top mosaic's CSS file.

In one embodiment, an instance method begin( ) is implemented in the ServletProcessor class. In that it prepares an html file's <head> section and uses <link> html element with its “REL” attribute set to “StyleSheet”, and references the external CSS file of a page or the external CSS file of a request URI's action class, and all the top level mosaics' external CSS files; for a transferred MosaicHanger which is produced by a MosaicHangerOnTree operation, the external CSS file of the MosaicHangerOnTree's associated page is also referenced. One or more static external CSS files can also be included in the <head> section. If an html file is dynamically generated, a temporary external CSS file associated with a session and with the same lifetime of the session can also be included, which means a user can modify the look and feel temporarily only for the session by changing the style sheets information and saving it in the temporary CSS file for reference. The changed style sheets information is transferred back to the server-side by Ajax (Asynchronous JavaScript and XML) with a CSS element ID and an attribute as well as the attribute's new value. The method also finds out mosaics hanged on the head section and gets the contents of the mosaics embedded in the head section.

In one embodiment, in one web browser, a page's html file is presented in one html frame, ManageCss and ManageCssElement to define and modify the page's CSS element's style sheets information is conducted in another html frame. When changes are submitted, the first frame is reloaded or refreshed immediately to reflect the new changes on style sheets definitions. This provides a good WYSIWYG (What You See Is What You Get) editing environment.

A mosaic, as a component, is exposed as a service or web service. When other website or websites request the service and identify a mosaic, the content represented by the mosaic and embedded with its external CSS file (if any) are sent to the requesting website which subsequently embeds the content in its web page or pages. The service can also act as a delegate or proxy for getting the information from another website and then sending it back to the requesting website. This enables the syndication of websites and content in one website can be reused in other website or websites. Website syndication is loosely coupled and integrated on component level, and is suitable for Publish/Subscribe system and dynamic network topology.

A permission mechanism is defined for who has the power to create and manage its own contents in a website as well as manage others' contents in a website. This mechanism also applies to any other data associated with the website. The various levels of permissions are defined as: none, read, edit, delete, create, with each has more power than the previous one and represented by number 0, 1, 2, 3, 4 respectively; The roles of permissions are defined as: creator, manager, which is represented by number 1, 2 respectively. A creator role can only handle its own contents and a manager role has more power and can handle others' contents.

PermissionGroup class is defined and a PermissionGroup is used to define a permission group with a valid time period identified by a starting time “startTime” and a stop time “stopTime”, in that period, the group and its related definitions takes effects.

PermissionGroupPermission class defines a permission group's permission role and permission level on one type of Entities; here an Entity's fully qualified class name is used as reference. Multiple PermissionGroupPermissions can be assigned to a permission group.

PermissionGroupMember class defines a permission group's user list which only a user in the list can perform an act or acts as the specified permissions allow.

PermissionGroupLocation class defines a permission group's location list that a user has to come from a location within the list to be able to perform an act or acts as the specified permissions allow. Here a location means a user's computer IP address.

A database table named “Permission” holds all the records of the highest permission level of all the possible combinations of the factors of a permission group; here a combination of the factors means a combination of a user, a location, an Entity's fully qualified class name, a permission role. The records are not generated at the time they are defined rather at the time when a user send in a request which subsequently provokes a permission level check, then related record or records are generated. The records are regularly updated at a predefined interval. By doing this, “Permission” database table can avoid being over-populated and provide a quicker and more efficient permission level check procedure.

In related to the “Permission” database table, Permission class is defined and used to hold the information of a record in the “Permission” database table and implements a method named “getPermissionLevel” which gets back a permission level by supplying the information of a user, a location, a fully qualified class name of an Entity, and a permission role.

In one embodiment, a commonly used method named “checkAccess” is implemented in a base class ServletBase (an abstract class) which extends HttpServlet class. The base class can be extended by a request URI's action class so some commonly used methods can be placed in the base class. The method “checkAccess” returns an Integer[ ][ ], a two dimensional array of permission levels as Integers; the first dimension represents different type of Entity classes involved when performing an action and the dimension's length equals the number of different type of Entity classes; the second dimension represents permission roles, the dimension's length is 2, its first index represents permission role of “creator” and its second index represents permission role of “manager”.

In one embodiment, ManagePage class, the action class of a request URI “/servlet/ManagePage” and a subclass of ServletBase and an implementation of ServletPresentation, uses Page class and invokes the “checkAccess” method to check a user's permission level to determine whether or not the user can create or manage a page and provides a browser-based user interface for handling the tasks. ManageMosaic class, the action class of another request URI “/servlet/ManageMosaic” and a subclass of ServletBase and an implementation of ServletPresentation, uses Mosaic class and invokes the “checkAccess” method to check a user's permission level to determine whether or not the user can create or manage a mosaic and provides a browser-based user interface for handling the tasks.

To regulate a page's accessibility, an access mechanism is defined for who has the power to access and manage a page. The various levels of access are defined as: none, read, edit, delete, create, with each has more power than the previous one and represented by number 0, 1, 2, 3, 4 respectively; Here an access level is equal to a corresponding permission level, but an access level will always be at “manager” permission role of having the capability to handle others' pages. There are two types of definitions used: The first one is a PublicAccess class which marks a page accessible to the public at a specified access level; The second one is AccessGroup, details described as below:

AccessGroup class is defined and a AccessGroup is used to define an access group with a valid time period identified by a starting time “startTime” and a stop time “stopTime”, in that period, the group and its related definitions takes effects. It also has a field “owner” identifying who owns the access group currently, a field “modifiedtime” to mark the last time it was modified. As a subset of Entity, AccessGroup's presentation is through AccessGroupPresentation class which implements EntityPresentation interface.

AccessGroupMember class defines an access group's user list that only a user in the list can access a page that the access group is assigned to at a specified access level.

AccessGroupLocation class defines an access group's location list that a user has to come from a location within the list to be able to access a page that the access group is assigned to at a specified access level. Here a location means a user's computer IP address.

In defining a page's access level, an instance of PageAccess class as well as a database table named “PageAccess” holds the information of a page's identifier, the fully qualified class name of the PublicAccess class, and an access level. A page can only have one-on-one relationship with PublicAccess class; yet another instance of PageAccess class as well as the same database table named “PageAccess” holds the information of a page's identifier, an identifier of an access group, the fully qualified class name of the AccessGroupPresentation class, and an access level. A page can be assigned multiple access groups at different access levels. A page cannot be assigned both PublicAccess and an access group together. A field named “accessclassname” in Page class holds the fully qualified class name of either PublicAccess class or AccessGroupPresentation class, if it holds nothing, a page is private and has not been defined any accessibility.

A page's PublicAccess access level can be obtained by just checking a database table named “PageAccess” with the page's identifier and the fully qualified class name of PublicAccess class. For AccessGroup, a database table named “Access” is used to hold all the records of the highest access level of all the possible combinations of the factors of an access group, here a combination of the factors means a combination of a user, a location, and a page's identifier. The records are not generated at the time they are defined rather at the time when a user accesses a page and provokes an access level check, and then related record or records are generated and regularly updated at a predefined interval. By doing this, “Access” database table can avoid being over-populated and provide a quicker and more efficient access level check procedure.

In related to the “Access” database table, Access class is defined and used to hold the information of a record in the “Access” database table and implements a method named “getAccessLevel” which gets back an access level by supplying the information of a user, a location, and a page's identifier.

In one embodiment, another commonly used method named “checkAccess” is implemented in the base class ServletBase (an abstract class, can not be instantiated and serve as a base or placeholder for some commonly used instance variables and methods used by subclasses). The “checkAccess” method requires the information of an Entity instance's identifier and the Entity's EntityPresentation implementation class, and returns an Integer[ ][ ], a two dimensional array of access levels as Integers; the first dimension represents the Page class involved when performing an action and the dimension's length equals 1; the second dimension represents permission roles, the dimension's length is 2, its first index represents permission role of “creator” and its second index represents permission role of “manager”, but an access level is always at “manager” permission role. If an Entity instance is not a page, its mapped page must be obtained by PageMap class, otherwise return null.

In one embodiment, ManagePage class, the action class of request URI “/servlet/ManagePage” and a subclass of ServletBase and an implementation of ServletPresentation, uses a page's identifier and PagePresentation class and invokes the “checkAccess” method to check a user's access level to determine whether or not the user can access and manage a page. ManageMosaic class, the action class of request URI “/servlet/ManageMosaic” and a subclass of ServletBase and an implementation of ServletPresentation, uses a mosaic's identifier and MosaicPresentation class and invokes the “checkAccess” method to check a user's access level to determine whether or not the user can access and manage a mosaic.

A page's accessibility can be managed individually. The accessibility of a group of pages can be managed by applying some filtering conditions on a directory tree to filter out the pages and assign accessibility definitions.

When a user starts a request and visiting on a website, a session is stated and lasted during the user's visit, when the user left, the session will wait until a predefined timeout period is elapsed and then expired. A session is assigned an unique ID to identify itself. A session spans multiple requests and is used to store exchanged information between a user (client side) and a website (server side). A data stored in a session uses “setAttribute” method to save and “getAttribute” method to retrieve by a name and value pair. These behaviors typically implemented in a web application server that includes a web container which provides the services.

In one embodiment, ServletSession class is defined and used as an adpater or facade to access and manipulate information stored in a session. When a request is received, a new instance of ServletSession is instantiated and identified by a session's session ID.

When instantiating a ServletSession instance, a memory area or Hashtable named “sessionScopeHashtable” is retrieved by the session ID as the key (or created if not yet existed), and used to store session-scope wide information so threads processing any requests can have access to session-scope wide information. The sessionScopeHashtable is saved in the session with the session ID as its key by a method setAttribute(session ID, sessionScopeHashtable).

When instantiating a ServletSession instance, another memory area or Hashtable named “requestScopeHashtable” is retrieved by a request's URI as the key (or created if not yet existed), and used to store accumulated request-scope wide information on a specific request URI so threads processing any requests can have access to the accumulated request-scope wide information on the specific request URI. The requestScopeHashtable can be either saved in the session with the request URI as its key by a method setAttribute(request URI, requestScopeHashtable), or saved in the sessionScopeHashtable with the requestURI as its key by a method put(request URI, requestScopeHashtable) in a nested Hashtable.

The request's getParameterMap( ) method returns an immutable java.util.Map instance containing parameter names as keys and parameter values as map values. The keys in the parameter map are of type String. The values in the parameter map are of type String array. The map is putting into its requestScopeHashtable whenever the same request URI is visited with new parameter/value pair added or same parameter but new value replacing old value. By doing so, the history and accumulated information is stored for a request URI and ready to be accessed by threads processing any requests with different request URI. The lifetime of a requestScopeHashtable lasts as the same of a session. The most current request information is still maintained and accessed at the request and is different from the accumulated memory Hashtable.

When combining the power of Ajax (Asynchronous JavaScript and XML technology), it provides an exceptional programming framework for web-based application development. The framework is very helpful when multiple requests with different request URIs need to work together and coordinate with each other. For example, on client side, a user interface has multiple frames in one web browser and each frame presents a response of a different request URI, data and information exchange between different frames can be accomplished through JavaScript, Document Object Model, etc. Between the client side and server side, data and information on the client side can be sent back to the server side by Ajax and saved into a requestScopeHashtable without the need to reload a web page. Data and information are structurally organized and saved in the server side according to each request's request URI, they can be accessed and changed any time by either server side or client side during the lifetime of a session.

In one embodiment, a frame in the left side body of a web browser is used to display navigation view of page directory tree by a request URI named “/servlet/ExploreDirectory”. In it, a parent page is identified by a parameter named “ParentPage”. A second frame in the right side body of the same web browser is used to display a list of child pages of the parent page by a request URI named “/servlet/PageChildList”.

When the second frame turns to another request URI of “/servlet/ManagePage” to create a new page, the “ParentPage” information is retrieved from the requestScopeHashtable of “/servlet/ExploreDirectory” and makes it the parent page of the newly created page.

When the second frame turns to another request URI of “/servlet/ManageMosaic” to create a new mosaic, the “ParentPage” information is retrieved from the requestScopeHashtable of “/servlet/ExploreDirectory” and makes it the parent page of the newly created page mapping the newly created mosaic in a method named “mapPage” implemented in ServletBase.

When the second frame turns to another request URI of “/servlet/ManageDocument” to create a new document, the “ParentPage” information is retrieved from the requestScopeHashtable of “/servlet/ExploreDirectory” and makes it the parent page of the newly created page mapping the newly created document in the same method named “mapPage” implemented in ServletBase. The underlying action class of “/servlet/ManageDocument” is ManageDocument, which implements ServletPresentation and is a subclass of ServletBase;

When the second frame turns to another request URI of “/servlet/ManageMusic” to create a new music, the “ParentPage” information is retrieved from the requestScopeHashtable of “/servlet/ExploreDirectory” and makes it the parent page of the newly created page mapping the newly created music in the same method named “mapPage” implemented in ServletBase. The underlying action class of “/servlet/ManageMusic” is ManageMusic, which implements ServletPresentation and is a subclass of ServletBase;

When the second frame turns to another request URI of “/servlet/ManagePicture” to create a new picture, the “ParentPage” information is retrieved from the requestScopeHashtable of “/servlet/ExploreDirectory” and makes it the parent page of the newly created page mapping the newly created picture in the same method named “mapPage” implemented in ServletBase. The underlying action class of “/servlet/ManagePicture” is ManagePicture, which implements ServletPresentation and is a subclass of ServletBase;

The same are for “/servlet/ManageVideo”, “/servlet/ManageSearchBox”, “/servlet/ManageAccessGroup”. The point is here made that the “ParentPage” information does not need to be carried or embedded in each request URI's request, it can be just stored in one place, even though the information can be stored in the sessionScopeHashtable for every request to access, but putting every information in one flat place would be a mess and not a best practice. The underlying action class of “/servlet/ManageVideo” is ManageVideo and the underlying action class of “/servlet/ManageSearchBox” is ManageSearchBox and the underlying action class of “/servlet/ManageAccessGroup” is ManageAccessGroup, they all implements ServletPresentation and subclasses of ServletBase;

In one embodiment, Explorer class, the action class of “/servlet/Explorer” and a subclass of ServletBase, implements ServletPresentation. An instance of Explorer class generates a group of four frames organized into three framesets in a web browser:

The first frame is at top body area and identified by an ID “F0”. F0 presents a series of html buttons that presents each menu or action selection to be invoked which will subsequently change other frames' URLs and reload those frames. A button or menu is identified by a “MenuId” which corresponds to a number named “MenuIndex”. F0's content is generated by a request URI “/servlet/Menu” with Menu class as its action class. “/servlet/Menu” is the value of frame F0's attribute “src”.

The second frame is at left side body area and identified by an ID “F1”. F1 presents a directory tree navigation view. The possible values of its “src” attributes are: “/servlet/ExplorePublicDirectory”, “/servlet/ExploreAccessGroupDirectory”, “/servlet/ExploreDirectory”, “/servlet/ExploreAccess”, “/servlet/ExploreAssembly”, which has its action class as ExplorePublicDirectory, ExploreAccessGroupDirectory, ExploreDirectory, ExploreAccess, and ExploreAssembly, respectively.

The third frame is at right side body area but at an upper position and identified by an ID “F2”. F2 presents the list view of child pages either in detail mode or in thumbnail mode, it also presents the page view of an entity and other management and editing interface, etc. The possible values of its “src” attribute are: “/servlet/PageChildPublicList”, “/servlet/PageChildAccessGroupList”, “/servlet/PageChildList”, “/servlet/PageChildAccessList”, “/servlet/Page”, which has its action class as PageChildPublicList, PageChildAccessGroupList, PageChildList, PageChildAccessList, PageServlet, respectively. Each request URI may invoke its own and another request for further action.

The fourth frame is at right side body area but at the bottom position and identified by an ID “F3”. F3 presents an action interface to do operations and then reflect the results on frame F1 and F2, etc. The possible values of its “src” attribute are: “/servlet/ManagePageAccessTree”, “/servlet/HangMosaic”, with each's corresponding action class as ManagePageAccessTree, HangMosaic, respectively. Each request URI may invoke its own and another request for further action.

The first frameset element identified by an ID “FS0” encloses all the frames, and it separates F0 from the rest which are organized into another frameset with ID as “FS1”. String “23, *” is defined as the initial value of FS0's “rows” attribute which means a height definition 23 pixels for F0 and the rest of height for FS1. String “100%” is defined as the initial value of FS0's “cols” attribute which means F0 and FS1 both extends to the full width of a web browser.

The second frameset FS1 encloses F1, F2, and F3, but separates F1 from F2 and F3. F2 and F3 are organized into another frameset with ID as “FS2”. The initial value of FS1's “rows” attribute is defined as “100%” which means both F1 and FS2 extends to the full height of FS1; The initial value of FS1's “cols” attribute is defined as “20%, 80%” which means F1 occupies 20% of FS1's width and FS2 occupies 80% of FS1's width.

The third frameset FS2 encloses F2 and F3. Its “rows” attribute's initial value is defined as “60%, 40%” which means F2 occupied 60% of FS2's height at the top and F3 occupied 40% of FS2's height at the bottom. FS2's “cols” attribute's initial value is defined as “100%” which means both F2 and F3 extends to the full width of FS2. The initial value of FS2's “rows” attribute may have variants such as “*, 0” or “80%, 20” depending on the initial requirements, but this is not really important.

The important thing is that when a user adjusts the sizes of frames, how can the system be able to track the changes and maintain the new sizes when a reload is needed or when a refresh is invoked. The second important thing is to track the URL (Uniform Resource Locator) or “href” attribute of each frame under different MenuId or MenuIndex selections. A JavaScript function named “saveSizes” with all the frames' IDs as argument passing in to get the height and width information of each frame in a web browser and with an Ajax function call to send these data back to server side, is embedded in frame F0 and F3 listening on the frames' onresize event. Another JavaScript function named “saveUrl” with a frame's ID as argument passing in to get the URL or “href” attribute of the frame and with an Ajax function call to send the information back to server side, is embedded in each frame listening on each frame's onload event. On the server side, an instance of the Explorer class receives the information, processes the information and stores them in its requestScopeHashtable. When a request is called on “/servlet/Explorer” with a MenuIndex, according to the specified MenuIndex or by using default 0, the action class Explorer retrieves each frame's saved URL as well as size information, the size information are used to reconstruct the definition of each frameset's “rows” and “cols” attributes. So the proper frame layout and URL information can be maintained and gets back to a user as expected. All of these provide a good user interface to interact with.

At MenuIndex=0, on left hand side, frame F1 displays one group of “Public” pages' directory tree navigation view. These pages have been granted public access. The request URI for F1 is “/servlet/ExplorePublicDirectory” which corresponds to the underlying action class ExplorePublicDirectory. There are two navigation modes: “Directory View” and “Page View”. “Directory View” only navigates down to a directory page (parent page). And when a user clicks on a directory page, on the right hand side, frame F2 shows a list of child pages of that parent page with detail information listed under “Details” view mode and with thumbnails representing each child page under “Thumbnails” view mode. The request URI for F2 is “/servlet/PageChildPublicList” which corresponds to the underlying action class PageChildPublicList. On the other hand, “Page View” can navigate down to every page in a directory tree, and when a user click any one of the page in the tree, the page's html file will show up in frame F2 on the right hand side. The request URI for F2 is “/servlet/Page” which corresponds to the underlying action class PageServlet which is a subclass of ServletBase class and implements ServletPresentation.

At MenuIndex=1, on left hand side, frame F1 displays one group of “Share” pages' directory tree navigation view. These pages have been granted an access group or groups for a user. The request URI for F1 is “/servlet/ExploreAccessGroupDirectory” which corresponds to the underlying action class ExploreAccessGroupDirectory. There are two navigation modes: “Directory View” and “Page View”. “Directory View” only navigates down to a directory page (parent page). And when a user clicks on a directory page, on the right hand side, frame F2 shows a list of child pages of that parent page with detail information listed under “Details” view mode and with thumbnails representing each child page under “Thumbnails” view mode. The request URI for F2 is “/servlet/PageChildAccessGroupList” which corresponds to the underlying action class PageChildAccessGroupList. On the other hand, “Page View” can navigate down to every page in a directory tree, and when a user clicks any one of the page in the tree, the page's html file will show up in frame F2 on the right hand side. The request URI for F2 is “/servlet/Page” which corresponds to the underlying action class PageServlet.

At MenuIndex=2, on left hand side, frame F1 displays one group of “Root” pages' directory tree navigation view. These pages are all the pages either owned by a user or the user has manager power over with. The request URI for F1 is “/servlet/ExploreDirectory” which corresponds to the underlying action class ExploreDirectory. There are two navigation modes: “Directory View” and “Page View”. “Directory View” only navigates down to a directory page (parent page). And when a user clicks on a directory page, on the right hand side, frame F2 shows a list of child pages of that parent page with detail information listed under “Details” view mode and with thumbnails representing each child page under “Thumbnails” view mode. The request URI for F2 is “/servlet/PageChildList” which corresponds to the underlying action class PageChildList. On the other hand, “Page View” can navigate down to every page in a directory tree, and when a user clicks any one of the pages in the tree, the page's html file will show up in frame F2 on the right hand side. The request URI for F2 is “/servlet/Page” which corresponds to the underlying action class PageServlet. There is an html button named “NewDirectory” for invoking the creation of a Directory or DirectoryTyped page. There is another html button named “New” for invoking the creation of a specific Entity page if the parent page is a DirectoryTyped page, or a selectable Entity page from a list of Entities if the parent page is a Directory page. There are two html buttons named “Cut” and “Paste”. They are used to move a page or a directory tree around in the whole directory structure.

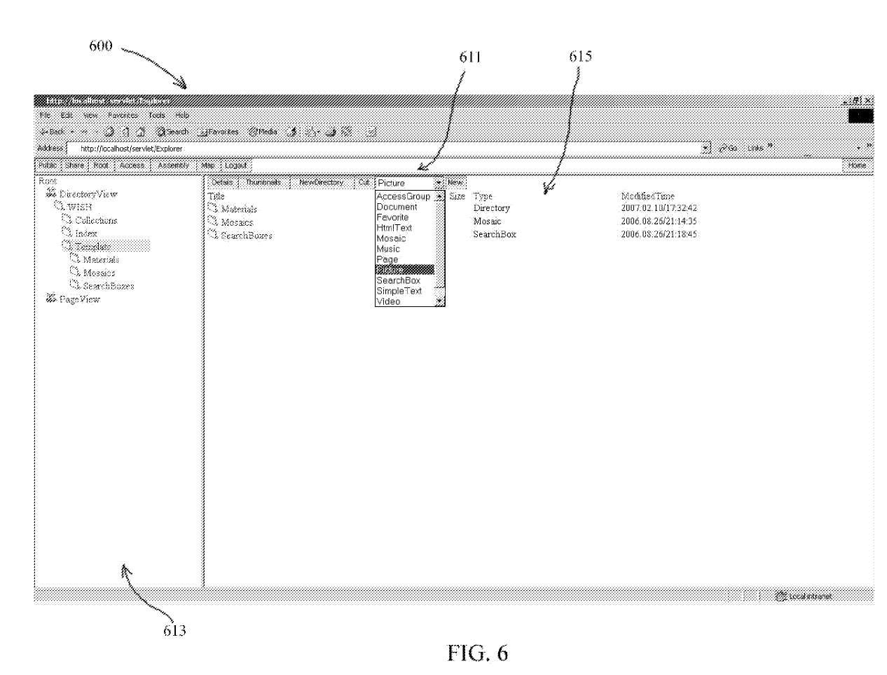

FIG. 6 is an exemplary embodiment of a browser-based user interface 600 at MenuIndex=2, where frame F0 611 is at top body area and directed to request URI “/servlet/Menu” which presents a series of html buttons that presents each menu or action selection to be invoked, frame F1 613 is directed to request URI “/servlet/ExploreDirectory” for viewing and navigation of directory tree structures and specifying a parent page, and frame F2 615 is directed to request URI “/servlet/PageChildList” for viewing of a list of child pages of the specified parent page and for creation and managing of pages;

At MenuIndex=3, on left hand side, frame F1 displays the directory tree navigation view of three groups of pages (Public, Share, Root). The navigation only navigates down to a directory page. The request URI for F1 is “/servlet/ExploreAccess” which corresponds to an underlying action class ExploreAccess. Once a directory page (parent page) is clicked on, on the right hand side, frame F2 is directed to request URI “/servlet/PageChildAccessList” which shows a list of child pages of the parent page with detailed information about each page's accessibility and access types (Private, Public, AccessGroup, at different access levels). Clicking an icon at the left side of a child page's title which a link is embedded with, brings the user interface down to a request URI “/servlet/ManagePageAccess” which corresponds to an underlying action class ManagePageAccess, where a page's accessibility can be managed individually. On the other hand, on the right hand side, frame F3 serves a request of request URI “/servlet/ManagePageAccessTree”, where proper access type and access level can be defined and applied to a directory tree of pages starting from the selected parent page, once applied by click the submit button, the result immediately reflected on frame F2.

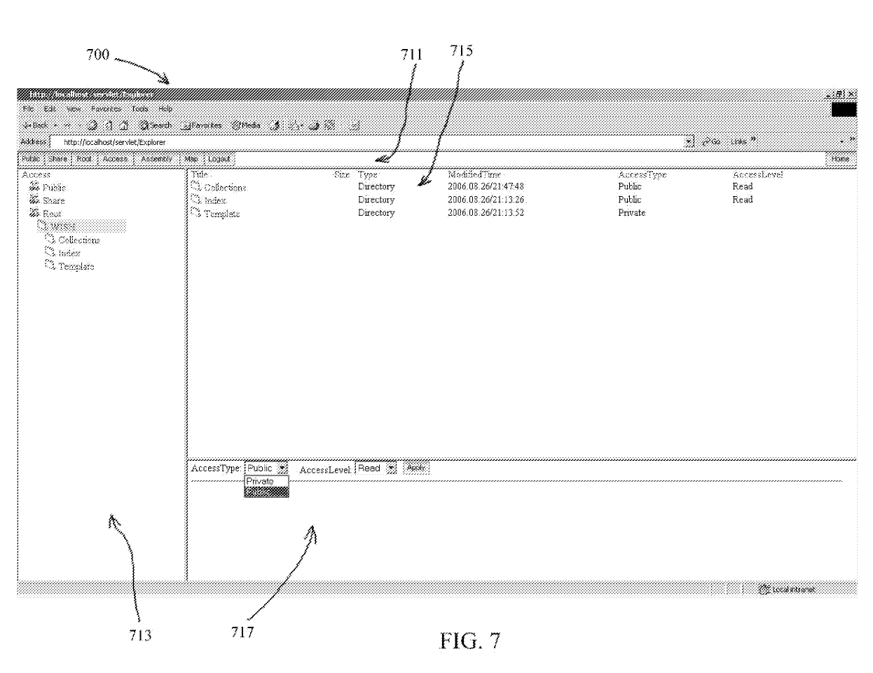

FIG. 7 is an exemplary embodiment of a browser-based user interface 700 at MenuIndex=3, where frame F0 711 is at top body area and directed to request URI “/servlet/Menu” which presents a series of html buttons that presents each menu or action selection to be invoked, frame F1 713 is directed to request URI “/servlet/ExploreAccess” for viewing and navigation of directory tree structures and specifying a parent page, and frame F2 715 is directed to request URI “/servlet/PageChildAccessList” for viewing of the accessibility of a list of child pages of the parent page, and frame F3 717 is directed to request URI “/servlet/ManagePageAccessTree” for creation and modification of accessibility of a whole tree of pages starting from the specified parent page.

At MenuIndex=4, on left hand side, frame F1 displays the directory tree navigation view of two groups of pages. The first group only includes pages and pages mapped with Mosaic entity, but excludes pages mapped with other entities. The second group includes all the pages except pages of Specific and Reference types which do not mapped with any entities. Frame F1 serves a request of request URI “/servlet/ExploreAssembly” which corresponds to an underlying action class ExploreAssembly. When one of the pages in the first group is selected, on the right hand side, frame F2 shows the html file the page representing by a request of request URI “/servlet/Page” which corresponds to an underlying action class PageServlet. On the right hand side, frame F3 shows some embedded html buttons named “ViewMode”, “EditMode”, “EditCSS”, and “TreeOperation”, along with two input fields to input the hanging position of X and Y values, the presentation is served through a request of request URI “/servlet/HangMosaic” which corresponds to an underlying action class HangMosaic. When one of the pages (Specific type, mapped with a specific entity) in the second group is selected, frame F3 also shows the embedded presentation of that specific entity so an author can use that entity to hang on a page or a mosaic selected from the first group. “ViewMode” is the default. When “EditMode” is invoked by clicking the button, the view of frame F2 shows some embedded html buttons for each mosaic's removing and editing with its hanging position information shown, along with each slice's html table and cell elements' border appearing bold to show the nested structure information. This result is achieved in FeaLattice and FeaMosaicHanger threads by turning a field named “_iMode” in an instance of ServletProcessor from “NORMAL” into “MANAGE”. Here “NORMAL” and “MANAGE” are number 0 and 1 respectively. When “TreeOperation” is invoked by clicking the button which leads to a request of request URI “/servlet/HangMosaicOnTree” which corresponds to an underlying action class HangMosaicOnTree, filtering conditions show up for selection to hang an entity to those pages in the directory tree, starting from the page selected on the first group and according to the selected filtering conditions. When “EditCSS” is invoked which leads to a request of request URI “/servlet/ManageCss” which corresponds to an underlying action class ManageCss, frame F3 shows and lists each slice's corresponding table and its row and cell elements as well as each element's style sheets information, an html button named “Edit” for each element is provided for getting down to each individual element's management interface to manage its style sheets information, with a request of request URI “/servlet/ManageCssElement” and an underlying action class ManageCssElement.

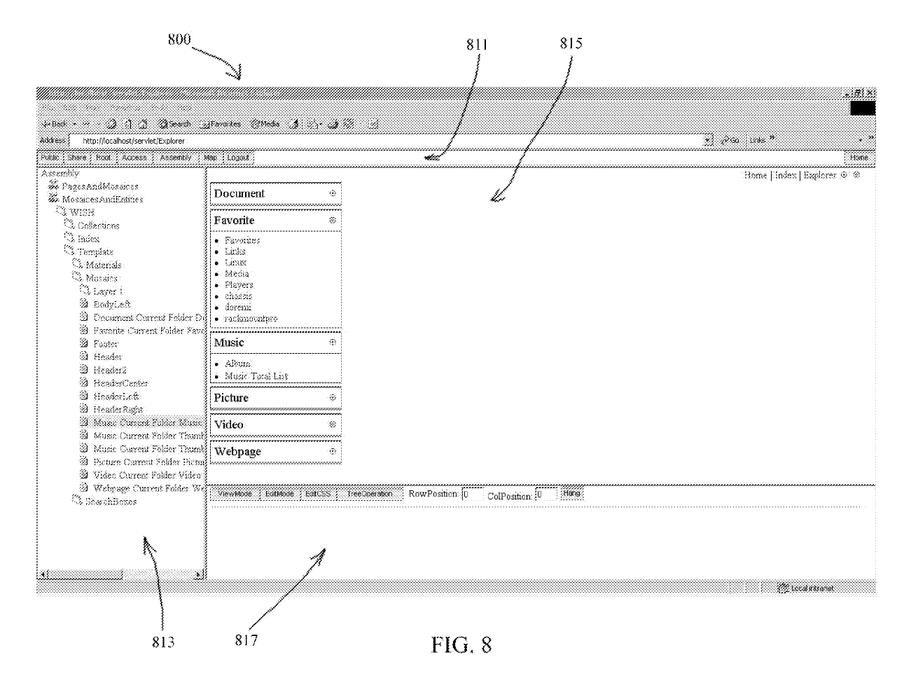

FIG. 8 is an exemplary embodiment of a browser-based user interface 800 for displaying and assembling a Page at MenuIndex=4, where frame F0 811 is at top body area and directed to request URI “/servlet/Menu” which presents a series of html buttons that presents each menu or action selection to be invoked, frame F1 813 is directed to request URI “/servlet/ExploreAssembly” for viewing and selection of Pages and Mosaics as well as viewing and selection of Mosaics and Pages mapped with specific entities, frame F2 815 is directed to request URI “/servlet/Page” for viewing of the selected Page at either view mode (“NORMAL” mode) or edit mode (“MANAGE” mode), frame F3 817 is directed to request URI “/servlet/HangMosaic” for hanging a selected Mosaic or an entity on the selected Page.

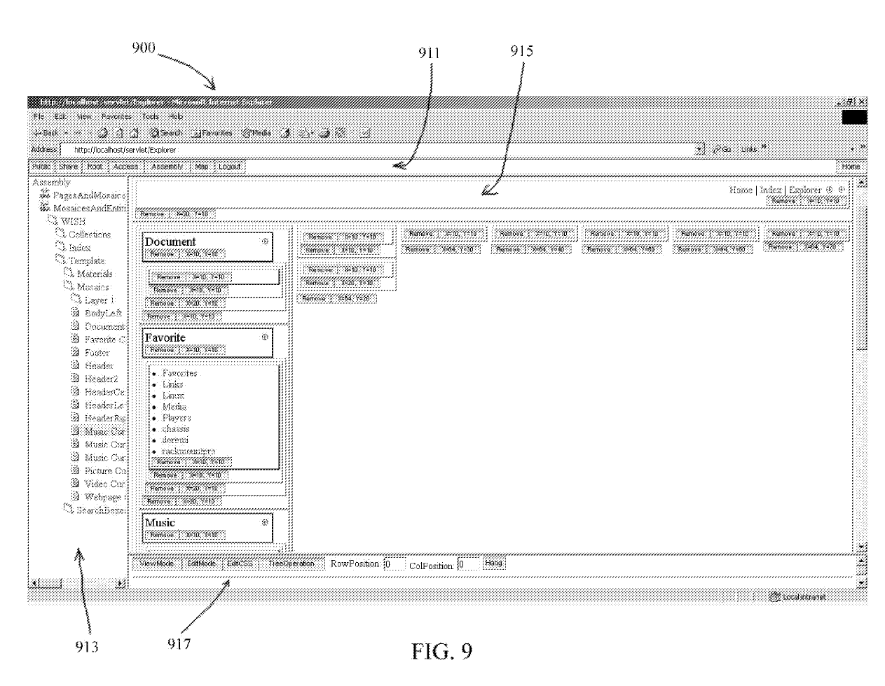

FIG. 9 is an exemplary embodiment of a browser-based user interface 900 for displaying and assembling a Page at MenuIndex=4, where frame F0 911 is at top body area and directed to request URI “/servlet/Menu” which presents a series of html buttons that presents each menu or action selection to be invoked, frame F1 913 is directed to request URI “/servlet/ExploreAssembly” for viewing and selection of Pages and Mosaics as well as viewing and selection of Mosaics and Pages mapped with specific entities, frame F2 915 is directed to request URI “/servlet/Page” for viewing of the selected Page at edit mode (“MANAGE” mode), frame F3 917 is directed to request URI “/servlet/HangMosaic” for hanging a selected Mosaic or an entity on the selected Page.

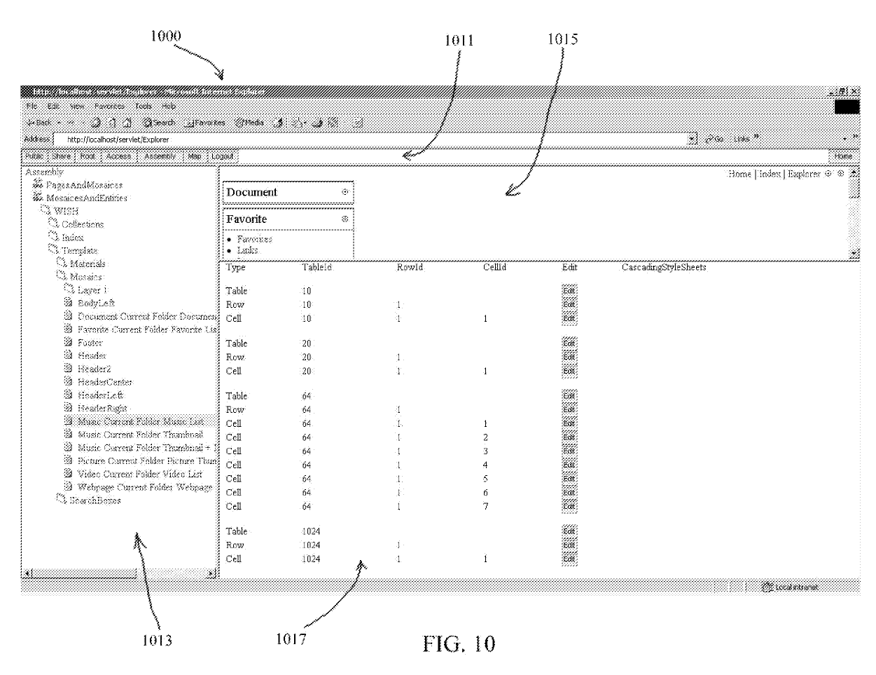

FIG. 10 is an exemplary embodiment of a browser-based user interface 1000 for displaying and managing CSS elements' style sheets information of a Page at MenuIndex=4, where frame F0 1011 is at top body area and directed to request URI “/servlet/Menu” which presents a series of html buttons that presents each menu or action selection to be invoked, frame F1 1013 is directed to request URI “/servlet/ExploreAssembly” for viewing and selection of Pages and Mosaics as well as viewing and selection of Mosaics and Pages mapped with specific entities, frame F2 1015 is directed to request URI “/servlet/Page” for viewing of the selected Page at either view mode (“NORMAL” mode) or edit mode (“MANAGE” mode), frame F3 1017 is directed to request URI “/servlet/ManageCss” which shows and lists each slice's corresponding table and its row and cell elements as well as each element's style sheets information where an html button named “Edit” for each element is provided for getting down to each individual element's management interface to manage its style sheets information.

In one embodiment, as a subset of Entity, Picture is defined as a subclass of Entity class and used to represent a picture. Its corresponding presentation class PicturePresentation implements the EntityPresentation interface for a picture's presentation. One of the implemented methods is getPresentation(HttpServletRequest req, HttpServletResponse resp, ServletSession ss, ServletProcessor sp, ServletBase sb, Object[ ] printid, Object identifier) which returns an object. Here the identifier identifies a picture entity. The creation and editing of a picture entity is through a request of request URI “/servlet/ManagePicture” which corresponds to an underlying action class ManagePicture. ManagePicture extends ServletBase class and implements ServletPresentation interface. The implemented method getPresentation(HttpServletRequest req, HttpServletResponse resp, ServletSession ss, ServletProcessor sp, ServletBase sb, Object[ ] printid) is responsible for constructing the response upon a request. During the creation or modification of a picture entity, a picture source file may be uploaded or changed, and a thumbnail or mid-range size pictures are created and used to present the picture instead of the original source file for fast response because of bandwidth consideration. The creation of a thumbnail or mid-range size pictures may take some time to finish. In order to reduce the time a user is waiting and accelerate the response, these tasks are put away into an asynchronous process by spawning a thread from inside ManagePicture's “doPost” method and sending out a request to a web application server to handle the asynchronous task. The structure and workflow to accomplish this are described as below:

ServerActionInterface interface defines a common method signature of performing an asynchronous task on server side, the signature of the method is as performAction(HttpServletRequest req, HttpServletResponse resp, ServletSession ss, ServletProcessor sp, ServletBase sb) which returns nothing.

ServerAction class and its corresponding database table named “ServerAction” are defined and used to hold associated information of an identifier that identifies an asynchronous task, a location that a task is initiated, the fully qualified class name of an implementation class of ServerActionInterface, a user information, a user's language preference, the timing of the task is initiated, a username and password randomly created at the time a task is initiated and for later authentication.

ServerActionController class, which extends ServletBase class, is defined and used to handle the receiving and dispatching of a request for starting an asynchronous task. The corresponding request URI is “/servlet/ServerActionController”. Upon receiving a request and after proper authentication, ServerActionController instantiates an instance of ServerActionInterface's implementation class and invokes its performAction method, and then returns after the execution of the method. An implementation class of ServerActionInterface may optionally further specify an action class that can be instantiated and executed from inside the performAction method. Of course the fully qualified class name of the action class need to be specified in the request as well if it is so desired, the performAction method can then parse it and proceeds with it.

Inside ManagePicture, a request is sent to “/servlet/ServerActionController” with associated information, and among them, the fully qualified class name of PicturePresentation which implements ServerActionInterface, and a fully qualified class name of an action class such as CreatePictureMetaData, CreateSubTypePicture, and CreateSubTypePictures. Upon receiving the request and after verifying the attached username and password with the values stored in database table “ServerAction”, ServerActionController instantiates an instance of PicturePresentation and invokes its performAction method. Inside the performAction method, the fully qualified class name of an action class is parsed and an instance is instantiated, and subsequently executed. CreatePictureMetaData parses a picture's Meta data such as its width and height information; CreateSubTypePicture creates a picture's mid-range size picture; CreateSubTypePictures creates a picture's thumbnail and mid-range size pictures.

In one embodiment, as a subset of Entity, Music is defined as a subclass of Entity class and used to represent a music. Its corresponding presentation class MusicPresentation implements the EntityPresentation interface for a music's presentation. One of the implemented methods is getPresentation(HttpServletRequest req, HttpServletResponse resp, ServletSession ss, ServletProcessor sp, ServletBase sb, Object[ ] printid, Object identifier) which returns an object. Here the identifier identifies a music entity. The creation and editing of a music entity is through a request of request URI “/servlet/ManageMusic” which corresponds to an underlying action class ManageMusic. ManageMusic extends ServletBase class and implements ServletPresentation interface. The method getPresentation(HttpServletRequest req, HttpServletResponse resp, ServletSession ss, ServletProcessor sp, ServletBase sb, Object[ ] printid) is responsible for constructing a response upon a request. During the creation or modification of a music entity, a music source file may be uploaded or changed, Meta data of the music are decoded and used to present the music. The decoding may take a little while. In order to reduce the time a user is waiting and accelerate the response, the task is put away into an asynchronous process by spawning a thread from inside ManageMusic's “doPost” method and a request is sent out to “/servlet/ServerActionController” with associated information, and among them, the fully qualified class name of MusicPresentation which implements ServerActionInterface, and a fully qualified class name of an action class such as CreateMusicMetaData. Upon receiving the request and after verifying the attached username and password with the values stored in database table “ServerAction”, ServerActionController instantiates an instance of MusicPresentation and invokes its performAction method. Inside the performAction method, the fully qualified class name of an action class CreateMusicMetaData is parsed and an instance is instantiated, and subsequently executed. CreateMusicMetaData parses a music's Meta data such as author, album, year, track, genre, copyright, and rating, etc.

Upon receiving a request, an instance of PageServlet class (a subclass of ServletBase class) parses a parameter named “Mode” for its value. This value will set the value of a field named “_iMode” in an instance of ServletProcessor. It has four possible values “NORMAL”, “MANAGE”, “SEMISTATIC”, “FULLSTATIC”, which corresponds to 0, 1, 2, and 3, respectively. The value decides whether a generated response will send back to a user's web browser as in the cases of “NORMAL” and “MANAGE”, or written down and saved in a local file for later retrieval as in the cases of “SEMISTATIC” and “FULLSTATIC”. Each mode's differences are briefly explained below:

“NORMAL” is the default mode.

When the mode is in “MANAGE”, some embedded html buttons appears for each mosaic's removing and editing with its hanging position information shown, along with each slice's html table and cell elements' border appearing bold to show the nested structure information. This result is achieved in FeaLattice and FeaMosaicHanger threads.

When the mode is in “SEMISTATIC”, a generated response is saved into a local file (a semi static file) for later retrieval with the page's identifier as its file name and “.htm” as its file extension. Upon receiving a request on the same page and depending on some filtering conditions (such as aging), this file may be retrieved and sent back to the user instead of dynamically generating a response again. Embedded links in a semi static file are in dynamic style such as “/servlet/Page” for accessing a page, and if they are not linked to static resources.

When the mode is in “FULLSTATIC”, a generated response is saved into a local file (a full static file) for later retrieval and making up an “eBook” with the page's identifier as its file name and “.html” as its file extension. This file is sent back to a user upon request. Embedded links are in static style such as “identifier.html” to access a page's html file. Upon completion, all the full static files and related static resources associated with the website are copied into a folder in the local hard drive, this makes up an eBook which can be started up and viewed from a web browser and get all the pages browsed without the need of a web application server or web server. The whole content in the folder can also be burned into a CD, DVD, or copied into a USB flash drive for storage or carrying around for later browsing just like a paper book, except that a computer with a web browser is needed.

When a page is visited or requested consecutively during a session, upon receiving the request, an instance of PageServlet class will set the value of a field named “_blRefresh” in an instance of ServletProcessor to true by its “setRefreshFlag” method. Under this condition, a page's html file is dynamically generated and sent back to a user. There is a cache mechanism implemented in the SearchBoxPresentation which stores the search result and presentation of last access in a memory block (a Hashtable), the next time the same SearchBox is accessed, the content stored in the cache will be returned instead of conducting the search and handling the presentation again. However, if the value of field “blRefresh” is true, this feature is disabled and a search and presentation will be fully conducted.

When reaching the end of generating a response and receiving a notification, a method end( ) with no argument and returns nothing and implemented in ServletProcessor, sends out whatever content residuals in the hierarchy of buffers and cleans it out. If the response encloses a frameset, then “</html> is attached to the end of the response, otherwise “</body></html>” is attached to the end of the response to finish up the whole response generating process. Depending on whether a page's identifier has been placed in the BeginHashtable under a key of “Fea.Page” which taken place in an instance of PageServlet, the end( ) method may send out a request by spawning a new thread to a request of request URI “/servlet/Page” with an identifier identifying a page and a “Mode” parameter of value “SEMISTATIC” specifying that a semi static file should be generated for the request and for later retrieval.

In the handling of a file uploading (a document, a picture, a music, a video, etc), the uploaded file is parsed, streaming to, and saved in a media server that is responsible for the management of a file for storage, retrieval, and delete. A generated pointer and the file's extension are used as a handle for a file's storage, delete, and retrieval. The parsing and streaming during uploading is handled in an instance of MultipartRequest class when it finds out the incoming request is of “multipart/form-data” type. MultipartRequest class is a super class of ServletSession class.

Media class is defined and used to represent a file. A media, an instance of Media class, is identified by a pointer and a file extension, the file extension can be null. A media uses a buffered input stream to retrieve a file through an instance method call of MediaClient class or getting it locally if the media server happens to be in the same computer machine. A media is deleted through an instance method call of MediaClient class or doing it locally if the media server happens to be in the same computer machine. An instance of MediaClient, when instantiated, sets up a Socket to communicate with a media server, and uses a buffered output stream to send out command and related parameters, and uses a buffered input stream to retrieve a file from the media server. A media server comprises of two parts: MediaServer class and MediaProcessor class. MediaServer sets up a ServerSocket on a default port (9498) and listens for incoming request. Once receiving a request, it will pass it over to an instance of MediaProcessor class, the instance of MediaProcessor will process the request accordingly for deleting a file, saving a file, or retrieving a file.

MediaInterface interface defines common method signatures that an Entity's EntityPresentation implementation class can implement, so a general way can be used to retrieve an external file not saving in a database whether it is a document, a picture, a music, or a video, etc. In one embodiment, a picture as a media is identified by its file extension and a pointer in the Picture class, an instance of PicturePresentation which implements MediaInterface gets the media through the getMedia method, and subsequently a buffered input stream is obtained for sending out the picture by a media's getBufferedInputStream method. A media have different subtypes such as a thumbnail and mid-size picture for a picture; the default value for a subtype is 0;

In one embodiment, GetMedia class, the action class of request URI “/servlet/GetMedia” and a subclass of ServletBase, is used to retrieve a media and send out to a user. Upon receiving a fully qualified class name of an Entity's EntityPresentation implementation class and an identifier identifying an Entity, as well as a username and password for authentication, a media is identified and retrieved by its buffered input stream, subsequently a response's output stream is used to send out the input stream to the requesting user. A media may further be identified by a subtype that has a default value of 0. The username and password are generated and stored in the mapped page during the creation or modification of an Entity. They are later retrieved and attached to a link of the media during an Entity's presentation generating process.

In one embodiment, as a subset of Entity and a subclass of Entity class, SimpleText class is defined and used to represent a block of plain text with no html code fragment included, so a block of plain text can be simply copied from its source and pasted into an instance of SimpleText, and presented as an html file through an instance of SimpleTextPresentation class which implements EntityPresentation interface. The creation, read, update, and removal are managed through ManageSimpleText which is a subclass of ServletBase and implements ServletPresentation;

In one embodiment, as a subset of Entity and a subclass of Entity class, HtmlText class is defined and used to represent a block of html code fragment, so a author can create or copy a block of html code fragment into an instance of HtmlText, and presented as an html file through an instance of HtmlTextPresentation class which implements EntityPresentation interface. The creation, read, update, and removal are managed through ManageHtmlText which is a subclass of ServletBase and implements ServletPresentation;

In one embodiment, as a subset of Entity and a subclass of Entity class, Favorite class is defined and used to represent a favorite link in Microsoft's Internet Explorer' “Favorites”. A favorite's url link is parsed and extracted from its underlying file and saved into an instance of Favorite which later is presented through an instance of FavoritePresentation class which implements EntityPresentation interface. The creation, read, update, and removal are managed through ManageFavorite which is a subclass of ServletBase and implements ServletPresentation;

In one embodiment, as a subset of Entity and a subclass of Entity class, Webpage class is defined and used to represent an html file and its associated content saved in a folder in a local hard drive. An html file and its associated content saved in a folder in a local hard drive come from an action conducted in a web browser environment, such as in Microsoft Internet Explorer, a user click “File” in the browser's top menu and then “Save As . . . ” which pops up a dialog window asking for a file name to be saved into and the default “Save as type:” in the dialog window as “Web Page, complete (*.htm, *.html)”. An instance of Webpage is presented through an instance of WebpagePresentation class which implements EntityPresentation interface. The creation, read, update, and removal are managed through ManageWebpage which is a subclass of ServletBase and implements ServletPresentation;

A document, picture, music, or video, can be created and mapped to a page one by one manually. On the other hand, a folder of files in a local hard drive can be created and mapped to pages automatically by a mapping thread upon specifying the folder' path and the corresponding Entity to create. A local file or folder's path information is saved with the corresponding entity created.

In one embodiment, ManageDirectoryMap class extends ServletBase and implements ServletPresentation interface. Inside its doGet method, a thread is spawned to send out an asynchronous request to ServerActionController along with the fully qualified class name of an action class CreateDirectoryMap, and ask for popping up a dialog window by invoking an instance of MapDirectory class that is instantiated inside the performAction method of an instance of CreateDirectoryMap class. Inside the dialog window, a user can navigate to a folder and subsequently select the type of Entity for the folder from a list of fully qualified class names of potential EntityPresentations, the list is generated by an instance of DirectoryFilter class. Once a user makes the choice, the information is saved into a local file and the folder's path is returned as the response, the folder's path is used as the local file's file name after the file separator character is replace with a period “.” Character. The ManageDirectoryMap also displays a list of currently selected folders, its specified entity type, the depth from the folder down to do mapping, the parent page which holds the mapped pages, and access definitions for the mapped pages. Access definition will inherit from the parent page. ManageDirectoryMapParent handles the selection of a parent page for a selected folder. A MapFileSystemThread thread will start mapping folders and files by invoking the mapPage instance method of MappingFileSystem class that navigates down to each folder, each file, one by one, creates the corresponding entity and a page mapped with it and handles other associated tasks, according to a folder's specified entity type. During the process, a file's path is translated into a relative URL that is used later for embedded link to retrieve the file. After completing the mapping process, each every page's semi static and full static html files are generated, and subsequently all the full static files and related static resources associated with the website are copied into a folder in the local hard drive to make up an eBook which can be started up from a web browser and get all the pages browsed without the need of a web server or web application server.

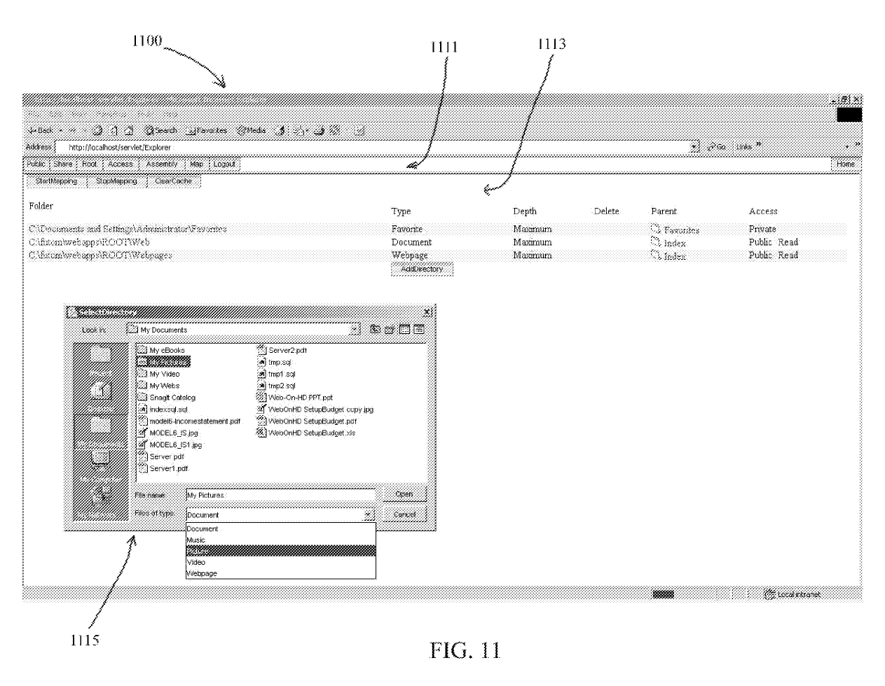

FIG. 11 is an exemplary embodiment of a browser-based user interface 1100 for displaying and managing a list of selected local folders and its specified entity types, where frame F0 1111 is at top body area and directed to request URI “/servlet/Menu” which presents a series of html buttons that presents each menu or action selection to be invoked, frame F1 1113 is directed to request URI “/servlet/ManageDirectoryMap” for viewing and managing of a list of selected local folders and its specified entity types, a pop-up dialog window 1115 allows a user navigate to a local folder and subsequently select the type of entity for the folder from a list of entities.

At the same time, since a folder and its files are selected arbitrarily by a user, these information are collected as a list of directory paths by a class method “getPublicDirectories” implemented in MapFileSystemThread, and passed to the DefaultServlet of Apache Tomcat when the website is deployed on Apache Tomcat web application server. The directory path information is gathered in ServletContextManager class that implements ServletContextListener and put into a ServletContext so it can be retrieved in DefaultServlet's serveResource method.

If a page is mapped to a local file or folder and a user browses the page by opening a web browser which is at the same computer machine with the web application server, a link embedded in the page's presentation, which is pointed to a request URI “/servlet/OpenFileSystem” and provided with the path information to a local file or folder the page mapped, can be invoked to open up the file or folder by the computer machine's file management program such as Windows Explorer. The underlying action class for “/servlet/OpenFileSystem” is OpenFileSystem class (a subclass of ServletBase). If a web application server is running in the backend and can not interact with a user, a same web application server parallelly running in the front end on a different port is needed, in such case, an instance of OpenFileSystem forwards the request to the front end web application server's “/servlet/ServerActionController” with the related information and asks for the action of OpenPath class (an implementation of ServerActionInterface) to open up the file or folder. This provides a seamless working environment of integrating web environment with local file management program. In one embodiment, a symbol “@” is used as the title of the link to indicate the significance of such a feature.

In one embodiment, Apache Tomcat is used as a web application server, which runs on a Java Virtual Machine (JVM) and includes a web container to provide service to web applications; a web browser open by a user can either run at the same computer machine with the web application server or run at a different or remote computer machine with communication connection to the web application server's computer machine.

A web application server includes a web container that is essentially the component of a web server that interacts with the servlets. A web container is responsible for managing the lifecycle of servlets, mapping a URL to a particular servlet and ensuring that the URL requester has the correct access rights.

A Servlet is an object that receives a request (ServletRequest) and generates a response (ServletResponse) based on the request. The Servlet API package javax.servlet.http defines HTTP subclasses of the generic servlet (HttpServlet) request (HttpServletRequest) and response (HttpServletResponse) as well as a session (HttpSession) that tracks multiple requests and responses between a web server and a client.

In one embodiment, ServletBase class extends HttpServlet class to receive the services provided by a web container, and for the receiving of a request and sending out a response. ServletBase implements a begin method with four arguments: an instance of HttpServletRequest, an instance of HttpServletResponse, an instance of ServletSession, and an instance of ServletProcessor, the begin method spawns a new thread which encapsulating the begin( ) method of the ServletProcessor instance; ServletBase also implements an end method with four arguments: an instance of HttpServletRequest, an instance of HttpServletResponse, an instance of ServletSession, and an instance of ServletProcessor, the end method encapsulates the end( ) method of the ServletProcessor instance; ServletBase also provides a convenient method of doIt for encapsulating the begin method and end method together.

In one embodiment, an instance of ServletRequest is passed in to instantiate an instance of MultipartRequest class for the parsing of parameter value pairs and binary streams uploading if the incoming request is of “multipart/form-data” type. ServletSession class extends MultipartRequest class;

In one embodiment, an instance of ServletProcessor class is instantiated by passing in instances of HttpServletRequest, HttpServletResponse, ServletSession, and ServletBase as four arguments of its constructor. ServletProcessor is responsible for the processing of an incoming request and generating the response.

As a general abstract class, an instance of FeaAbstract class holding the information of instances of HttpServletRequest, HttpServletResponse, ServletSession, ServletProcessor, and ServletBase. All instances of FeaAbstract class also share an instance of Resource class that provides internationalization and localization supports according to a user's different language preference.

Fea class is defined as a subclass of FeaAbstract class for the actual implementation and instantiation.

FeaMatrix class extends Fea class and implements the Runnable interface of Java Programming Language so an instance of FeaMatrix can be executed as a thread. An instance of FeaMatrix also is passed in the information of an object array as a key chain and a FeaFlag instance for matrixFlag and another FeaFlag instance for matrixFlagEnd and a list of MosaicHangers and generates the information of a group of slices and lattices in each slices after sorting out the list of MosaicHangers according to their X and Y values.

FeaSlice class extends FeaMatrix class. An instance of FeaSlice represents a slice and is passed in the information of the index of the slice in a group of slices and executed as a thread.

FeaLattice class extends FeaSlice class. An instance of FeaLattice represents a lattice in a slice and is passed in the information of the index of the lattice in a slice and an object the lattice is representing and executed as a thread.

FeaMosaicHanger class extends FeaLattice class. An instance of FeaMosaicHanger represents a MosaicHanger and is passed in the information of the index of the lattice in a slice and an identifier for a MosaicHanger and executed as a thread.

FeaBox class extends FeaLattice class. An instance of FeaBox represents a group of MosaicHangers regarding a rectangle area in a slice and is passed in the information of the index of a lattice in a slice and the group of MosaicHangers and executed as a thread.

FeaMosaic class extends Fea class and implements the Runnable interface of Java Programming Language so an instance of FeaMosaic can be executed as a thread. An instance of FeaMosaic is passed in the information of an object array as a key chain and an identifier identifying a Mosaic and executed as a thread.

In one embodiment, a database is one of SQL (Structured Query Language) type relational database management systems (MS SQL, Oracle, Apache Derby, or MySQL). A JDBC (Java Database Connectivity) driver is used to access and manipulate data saved in the database.

What is claimed is:

1. A system for modeling a web page generated by a web container, comprising:
an Entity defining the top superset of all entities and implementing common methods applicable for all entities;
a Mosaic extending said Entity and representing a component of said web page;
a Page extending said Entity and representing said web page;
a MosaicHanger extending said Entity and handling the relationship of hanging a Mosaic on a Page or another Mosaic at a horizontal or row position represented by X variable, and vertical or column position represented by Y variable;
a MosaicBinder extending said Entity and binding a Mosaic to an instance of an Entity except Page and Mosaic entities and having the Mosaic representing the Entity.

2. The system of claim 1, further comprising:
a PageMap extending said Entity and mapping a Page to an instance of an Entity except Page entities;
a PageChild extending said Entity and handling the relationship of a parent Page and its child Page;
a MosaicHangerOnTree extending said Entity and applying a Mosaic to a tree of Pages by hanging the Mosaic on filtered Pages at a horizontal or row position represented by X variable, and vertical or column position represented by Y variable;
a MosaicReference extending said Entity and handling the relationship of a Mosaic referencing another Mosaic either locally or remotely;
a PageReference extending said Entity and handling the relationship of a Page referencing another Page either locally or remotely.

3. The system of claim 1, further comprising:
a PublicAccess marking a Page's accessibility to the public at a specified access level of either none, read, edit, delete, or create, with each has more power than the previous one and represented by number 0, 1, 2, 3, 4 respectively;
an AccessGroup extending said Entity and representing an access group which defines a Page's accessibility by factors of a user information, the location the user comes from, a specified access level of either none, read, edit, delete, or create, with each has more power than the previous one and represented by number 0, 1, 2, 3, 4 respectively;
a PageAccess holding the information of a Page's accessibility information for authorization when a user accesses the Page;
a SearchBox extending said Entity and defining search criteria on directory tree of Pages and returning a list of entities that complies with the search criteria;
a Media representing a file not saved in a database and handling the retrieval and removal of the file.

4. The system of claim 1, further comprising:
an EntityPresentation defining signatures of common methods for presenting an Entity;
a MediaInterface defining signatures of common methods for retrieving a file not saved in a database;
a SearchInterface defining signatures of common methods for providing sorting support for search;
a ServerActionInterface defining signature of a common method for performing asynchronous tasks on said web container;
a SearchPresentation defining signature of a common method for presenting a list of entities produced by search and sorted by an instance of said SearchInterface;
a PagePresentation implementing said EntityPresentation, MediaInterface, SearchInterface, and ServerActionInterface for the presentation of a Page, retrieval of associated external file, sorting of a list of Pages produced by search, and execution of asynchronous task related to a Page;
a MosaicPresentation implementing said EntityPresentation for presentation of a Mosaic;
an AccessGroupPresentation implementing said EntityPresentation for the presentation of an AccessGroup;
a SearchBoxPresentation implementing said EntityPresentation for the presentation of a SearchBox.

5. The system of claim 1, further comprising:
a ServletProcessor for processing a request and generating a response;
a ServletBase extending HttpServlet to receive services provided by said web container and defining common methods for inheritance and use in its subclasses;
a ServletPresentation defining signature of a common method for generating the presentation of a response after receiving a request by said web container;
a MultipartRequest for parsing parameter value pairs and binary streams uploading if a request is of “multipart/form-data” type, and when being instantiated an instance of HttpServletRequest representing the request is passed in as sole argument;
a ServletSession extending said MultipartRequest and acting as an adapter or façade to access and manipulate information stored in an HttpSession, and when being instantiated an instance of HttpServletRequest representing a request is passed in as sole argument.

6. The system of claim 1, further comprising any of:
a Document extending said Entity and representing a document;
a Music extending said Entity and representing a music;
a Picture extending said Entity and representing a picture;
a Video extending said Entity and representing a video;
a Favorite extending said Entity and representing a favorite link in Internet Explorer's “Favorites”;
a Webpage extending said Entity and representing an html file and its associated content saved in a local folder;
a HtmlText extending said Entity and representing a fragment of html code;
a SimpleText extending said Entity and representing a block of plain text.

7. The system of claim 4, further comprising any of:
a DocumentPresentation implementing said EntityPresentation, MediaInterface, SearchInterface, and ServerActionInterface for the presentation of a Document, retrieval of associated external file, sorting of a list of Documents produced by search, and execution of asynchronous task related to a Document;
a MusicPresentation implementing said EntityPresentation, MediaInterface, SearchInterface, and ServerActionInterface for the presentation of a Music, retrieval of associated external file, sorting of a list of Musics produced by search, and execution of asynchronous task related to a Music;
a PicturePresentation implementing said EntityPresentation, MediaInterface, SearchInterface, and ServerActionInterface for the presentation of a Picture, retrieval of associated external file, sorting of a list of Pictures produced by search, and execution of asynchronous task related to a Picture;
a VideoPresentation implementing said EntityPresentation, MediaInterface, SearchInterface, and ServerActionInterface for the presentation of a Video, retrieval of associated external file, sorting of a list of Videos produced by search, and execution of asynchronous task related to a Video;
a FavoritePresentation implementing said EntityPresentation, MediaInterface, SearchInterface, and ServerActionInterface for the presentation of a Favorite, retrieval of associated external file, sorting of a list of Favorites produced by search, and execution of asynchronous task related to a Favorite;
a WebpagePresentation implementing said EntityPresentation, MediaInterface, SearchInterface, and ServerActionInterface for the presentation of a Webpage, retrieval of associated external file, sorting of a list of Webpages produced by search, and execution of asynchronous task related to a Webpage;
a HtmlTextPresentation implementing said EntityPresentation for the presentation of an HtmlText;
a SimpleTextPresentation implementing said EntityPresentation for the presentation of a SimpleText.

8. The system of claim 5, further comprising:
a PageServlet extending ServletBase and implementing ServletPresentation for generating said web page after receiving a request on a Page;
a ManagePage extending ServletBase and implementing ServletPresentation for providing a browser-based interface for the creation, reading, updating, and removal of a Page;
a ManageMosaic extending ServletBase and implementing ServletPresentation for providing a browser-based interface for the creation, reading, updating, and removal of a Mosaic;
a ManageAccessGroup extending ServletBase and implementing ServletPresentation for providing a browser-based interface for the creation, reading, updating, and removal of an AccessGroup;
a ManageSearchBox extending ServletBase and implementing ServletPresentation for providing a browser-based interface for the creation, reading, updating, and removal of a SearchBox.

9. The system of claim 5, further comprising:
a ServerActionController extending ServletBase and handling the receiving and dispatching of a request for starting an asynchronous task.

10. The system of claim 8, further comprising any of:
a ManageDocument extending ServletBase and implementing ServletPresentation for providing a browser-based interface for the creation, reading, updating, uploading, and removal of a Document;
a ManageMusic extending ServletBase and implementing ServletPresentation for providing a browser-based interface for the creation, reading, updating, uploading, and removal of a Music;
a ManagePicture extending ServletBase and implementing ServletPresentation for providing a browser-based interface for the creation, reading, updating, uploading, and removal of a Picture;
a ManageVideo extending ServletBase and implementing ServletPresentation for providing a browser-based interface for the creation, reading, updating, uploading, and removal of a Video;
a ManageFavorite extending ServletBase and implementing ServletPresentation for providing a browser-based interface for the creation, reading, updating, uploading, and removal of a Favorite;
a ManageWebpage extending ServletBase and implementing ServletPresentation for providing a browser-based interface for the creation, reading, updating, uploading, and removal of a Webpage;
a ManageHtmlText extending ServletBase and implementing ServletPresentation for providing a browser-based interface for the creation, reading, updating, and removal of an HtmlText;
a ManageSimpleText extending ServletBase and implementing ServletPresentation for providing a browser-based interface for the creation, reading, updating, and removal of a SimpleText.

11. The system of claim 1, wherein a Mosaic is bound to a ServletPresentation's implementation class to represent the output of an instance of the ServletPresentation's implementation class and the relationship is handled by a MosaicBinder with both the “identifier” field and “classname” field identifying the fully qualified class name of the ServletPresentation implementation class and a “mosaic” field identifying the Mosaic.

12. The system of claim 1, wherein a Mosaic is hanged on a ServletPresentation implementation class and the relationship is handled by a MosaicHanger with both the “identifier” field and “classname” field identifying the fully qualified class name of the ServletPresentation implementation class and a “mosaic” field identifying the Mosaic and the hanging position identified by X variable and Y variable.

13. The system of claim 1, wherein a Mosaic is hanged on the head section of said web page by specifying the hanging position's X and Y values both as negative.

14. The system of claim 1, wherein a Page is of four types: Specific, DirectoryTyped, Reference, and Directory.

15. The system of claim 14, wherein a Specific type Page is either a Page itself and not mapped to any entities, or a Page mapped to any entities other than Page as any one of a Mosaic, a Document, a Music, a Picture, a Video, a Favorite, a Webpage, a SimpleText, an HtmlText, a SearchBox, or an AccessGroup.

16. The system of claim 15, wherein a Page mapped to a Mosaic has a MosaicHanger hanging the Mosaic on the Page at a pre-defined position and a PageMap mapping the Page to the Mosaic.

17. The system of claim 15, wherein a Page mapped to an entity other than Page and Mosaic has a MosaicBinder binding a Mosaic to the entity and a MosaicHanger hanging the Mosaic on the Page at a pre-defined position and a PageMap mapping the Page to the entity.

18. The system of claim 14, wherein a DirectoryTyped type Page serves as a parent Page holding a group of child Pages mapped to a same type of Entity identified by the fully qualified class name of the Entity's EntityPresentation implementation class.

19. The system of claim 14, wherein a Reference type Page references another Page either locally or remotely, and the relationship of the referencing Page and the referenced Page is hold in a PageReference.

20. The system of claim 14, wherein a Directory type Page holds all types of Pages as its child Pages including another Directory type Page.

21. The system of claim 1, wherein a Mosaic is of four types: Specific, DirectoryTyped, Reference, and Directory.

22. The system of claim 21, wherein a Specific type Mosaic is either a Mosaic itself and not bound to any entities, or a Mosaic bound to any entities other than Page and Mosaic as any one of a Document, a Music, a Picture, a Video, a Favorite, a Webpage, a SimpleText, an HtmlText, a SearchBox, or an AccessGroup, and the binding relationship of the Mosaic with an entity is handled by a MosaicBinder.

23. The system of claim 21, wherein a DirectoryTyped type Mosaic acts as a parent Mosaic and is hanged on by a group of Specific Mosaics bound to a same type of Entity identified by the fully qualified class name of the Entity's EntityPresentation implementation class, and the relationship of a parent Mosaic and a child Mosaic which is hanged on the parent Mosaic is handled by a MosaicHanger.

24. The system of claim 21, wherein a Reference type Mosaic references another Mosaic either locally or remotely, and the relationship of the referencing Mosaic and the referenced Mosaic is handled by a MosaicReference.

25. The system of claim 21, wherein a Directory type Mosaic acts as a parent Mosaic and is hanged on by all types of Mosaics including another Directory type Mosaic.

26. The system of claim 1, wherein a Mosaic is bound to a function through a MosaicBinder for presenting the result out of performing the function.

27. The system of claim 1, wherein a Mosaic is bound to a SearchBox through a MosaicBinder for presenting the search result of the SearchBox.

28. The system of claim 1, wherein a Mosaic is exposed as a service by a proprietary API and consumed by other websites.

29. The system of claim 1, wherein a Mosaic is bound to a function of consuming a service exposed by a website's proprietary API through a MosaicBinder binding the Mosaic with the function.

30. The system of claim 1, wherein a Mosaic is exposed as a web service by WSDL (Web Service Description Language) to define a service endpoint and port and consumed by other websites for the reuse of the Mosaic.

31. The system of claim 1, wherein a Mosaic is bound to a function of consuming a web service exposed by a website's standardized WSDL through a MosaicBinder binding the Mosaic with the function of consuming a web service.

32. The system of claim 1, wherein a Mosaic is enclosed in a cell of a row of an html table, which are identified by unique IDs of cellID, rowID, and tableID, respectively, so the appearance of the Mosaic is adjusted by defining the style sheets information of cellID, rowID, and tableID and saving them in an external CSS file.

33. The system of claim 32, wherein an external CSS file identified by a Mosaic's identifier plus file extension “.css” contains all cellIDs, rowIDs, and tableIDs style sheets information of the Mosaic's all descendant Mosaics.

34. The system of claim 33, wherein the external CSS file is embedded in the output when the Mosaic is requested by other websites through a service.

35. The system of claim 3, wherein a SearchBox holds the information of a top Page of a directory tree that is going to be searched, a depth level indicating the search level from the top Page deep down to the directory tree, a type of Page the SearchBox is searching for, a fully qualified class name of an Entity's EntityPresentation implementation class indicating a specific type of Entity the SearchBox is searching for, a parameter a search is based upon for the order of the search result, a direction indicating the ascending or descending direction of the order.

36. The system of claim 4, wherein the signature of a common method of EntityPresentation, getPresentation, returns a result as an object and asks for seven arguments: an instance of HttpServletRequest representing a request, an instance of HttpServletResponse representing a response, an instance of ServletSession representing current session, an instance of ServletProcessor for processing the request and generating the response, an instance of ServletBase for receiving the request and sending out the response from a web container, an object array as a key chain representing a series of buffers, an object as identifier of an instance of an Entity.

37. The system of claim 4, wherein the signature of a common method of MediaInterface, getMedia, returns an instance of Media and asks for two arguments: an object as identifier of an instance of an Entity and a subtype of the Media.

38. The system of claim 4, wherein the signature of a common method of SearchInterface, sort, returns a sorted list of entities and asks for four arguments: an unsorted list of entities, a string specifying the “order by” parameter, a string specifying the order direction of either “asc” or “desc”, a language preference.

39. The system of claim 4, wherein the signature of the sole common method of ServerActionInterface, performAction, returns void or nothing and asks for five arguments: an instance of HttpServletRequest representing a request, an instance of HttpServletResponse representing a response, an instance of ServletSession representing current session, an instance of ServletProcessor for processing the request and generating the response, an instance of ServletBase for receiving the request and sending out the response from a web container.

40. The system of claim 4, wherein the signature of a common method of SearchPresentation, getPresentation, returns a result as an object and asks for eight arguments: an instance of HttpServletRequest representing a request, an instance of HttpServletResponse representing a response, an instance of ServletSession representing current session, an instance of ServletProcessor for processing the request and generating the response, an instance of ServletBase for receiving the request and sending out the response from a web container, an object array as a key chain representing a series of buffers, an object as identifier of a SearchBox instance, a sorted list of entities.

41. The system of claim 5, wherein a ServletProcessor is instantiated by four arguments: an instance of HttpServletRequest representing a request, an instance of HttpServletResponse representing a response, an instance of ServletSession representing current session, an instance of ServletBase for receiving the request and sending out the response from a web container.

42. The system of claim 41, wherein the instance of ServletProcessor implements a begin( ) method for starting the processing a request and generating a response, a shared object for synchronizing of all the threads spawned, a print( ) method with two arguments of an object array as a key chain and an object as the generated content for saving the content in a buffer and pushing the content in the buffer up one level in a hierarchy of buffers, a printed( ) method with one argument of an object array as a key chain for pushing the content saved in a buffer up one level in a hierarchy of buffers, and a end( ) method for ending the process.

43. The system of claim 5, wherein ServletBase implements a checkAccess method for the authorization of a user, a mapPage method for the mapping of a Page to an entity, an unmapPage method for the removing of the mapping relationship, a begin method spawning a new thread and encapsulating the begin( ) method of an instance of ServletProcessor, an end method encapsulating the end( ) method of the instance of ServletProcessor, a doIt method encapsulating the begin and the end methods.

44. The system of claim 5, wherein the signature of the sole common method of ServletPresentation, getPresentation, returns a result as an object and asks for six arguments: an instance of HttpServletRequest representing a request, an instance of HttpServletResponse representing a response, an instance of ServletSession representing current session, an instance of ServletProcessor for processing the request and generating the response, an instance of ServletBase for receiving the request and sending out the response from a web container, an object array as a key chain representing a series of buffers.

45. The system of claim 5, wherein an instance of ServletSession stores a sessionScopeHashtable for session scope wide information sharing and identified by a session ID in a HttpSession, and a requestScopeHashtable for accumulated information of each the same request URI visit of a session and identified by the request URI in a HttpSession.

46. A method of generating a web page by a web container, comprising:
receiving an instance of HttpServletRequest representing a request for said web page and an instance of HttpServletResponse for sending back a response by an instance of ServletBase;
instantiating an instance of ServletSession by the instance of HttpServletRequest;
instantiating an instance of ServletProcessor by the instance of HttpServletRequest, the instance of HttpServletResponse, the instance of ServletSession, and the instance of ServletBase;
executing a begin method of ServletBase after passing in the instance of HttpServletRequest, the instance of HttpServletResponse, the instance of ServletSession, the instance of ServletProcessor to the begin method;
executing a end method of ServletBase after passing in the instance of HttpServletRequest, the instance of HttpServletResponse, the instance of ServletSession, the instance of ServletProcessor to the end method.

47. The method of claim 46, wherein said step of executing a begin method further comprising:
spawning a thread and passing in the instance of HttpServletRequest, the instance of HttpServletResponse, the instance of ServletSession, the instance of ServletProcessor, and the instance of ServletBase to the thread;
executing the thread.

48. The method of claim 47, wherein said step of executing the thread further comprising:
executing the begin( ) method of the instance of ServletProcessor.

49. The method of claim 48, wherein said step of executing the begin( ) method further comprising:
instantiating an instance of FeaFlag named matrixFlag marking the starting point of a hierarchy of threads and passing it into the top thread of the hierarchy of threads;
instantiating an instance of FeaFlag named matrixFlagEnd passing it into the top thread of the hierarchy of threads and marking the ending point of the hierarchy of threads;
instantiating an object array with only one element which represents a buffer for saving generated contents and passing the object array into the top thread of the hierarchy of threads;
parsing a “Mode” parameter from the instance of HttpServletRequest and setting up the mode instance variable in the instance of ServletProcessor;
starting construction of the head section of the response;
embedding link references to external javascript files;
embedding link references to external style sheets files including a session related temporary external style sheets file;
finding out a list of MosaicHangers hanged on the head section of a Page if the request is requesting a Page or hanged on the head section of the ServletPresentation implementation class if the request is not a request requesting a Page;
fetching the content of each Mosaic associated with each MosaicHanger in the list;
embedding the content in the head section of the response;
finding out a second list of MosaicHangers hanged on a Page if the request is requesting a Page or hanged on the ServletPresentation implementation class if the request is not a request requesting a Page, excluding MosaicHangers hanged on the head section;
spawning a FeaMatrix thread for sorting the second list of MosaicHangers and processing, wherein the FeaMatrix thread is the top thread of the hierarchy of threads;
embedding link references to all Mosaics' external style sheets files according to the second list of MosaicHangers;
ending the head section of the response;
starting the body section if the response is not for a frameset html file;
flushing out the generated content;
putting the first element of the object array as a key and an instance of FeaFlag with value of true into a memory block beginHashtable of the ServletProcessor instance for indicating the buffer is ready for sending its saved content out;
waiting for the FeaMatrix thread's notification if the sorting is done or a timeout is elapsed then proceeds to next step;
setting the value of the matrixFlag to true;
setting the value of first element of sliceFlag of the matrixFlag to true;
setting the value of first element of latticeFlag of the first element of the sliceFlag to true;
notifying all threads waiting on a shared synchronizing object;
waiting on the shared synchronizing object for notifications from other threads and once the value of the matrixFlagEnd is true putting a key and an instance of FeaFlag with value of true into the beginHashtable;
notifying all other threads waiting on the shared synchronizing object.

50. The method of claim 49, wherein said step of spawing a FeaMatrix thread further comprising:
sorting the second list of MosaicHangers and grouping them into slices according to their X values and into lattices in a slice according to their Y values;
notifying other threads waiting on this thread that the sorting is done;
spawning FeaSlice threads one by one if there are slices from the sorting;
instantiating an FeaHelper instance and storing the sorting information in the instance for later retrieval to setup CSS elements;
putting the FeaHelper instance into a requestScopeHashtable with PagePresentation's fully qualified class name as a key;
ending the thread if there are slices; otherwise
waiting on the shared synchronizing object for the matrixFlag's value turning into true or a timeout is elapsed;
constructing a new object array as a new key chain by copying all elements from the object array passed into the FeaMatrix thread and by adding a new object element as a new key representing a new buffer in a hierarchy of buffers;
putting the new key and a new FeaFlag instance with a true value into the beginHashtable indicating the new buffer is ready for moving its saved content up to one level in the hierarchy of buffers;
instantiating an instance of ServletPresentation implementation class by using the fully qualified class name of the instance of ServletBase;
getting an object returned by executing the getPresentation method of the ServletPresentation instance with the new key chain, wherein the returned object might be null if the method already saves its generated content into buffers associated with the new key chain;
executing the print method of the ServletProcessor instance with the new key chain and the returned object for saving the object into the new buffer;
executing the printed method of the ServletProcessor instance with the new key chain for pushing up the content currently saved in the new buffer up to one level in the hierarchy of buffers;
setting the matrixFlagEnd's value into true for marking the end of the FeaMatrix thread;
notifying all other threads waiting on the shared synchronizing object.

51. The method of claim 50, wherein said step of spawning FeaSlice threads one by one further comprising:
spawning FeaLattice threads one by one in a slice;

52. The method of claim 51, wherein said step of spawning FeaLattice threads one by one further comprising:
if the lattice is the first element in a slice,
constructing the starting portion of an html table element for including the first cell element if the response is not an frameset html file and enabling the table's border appeared to be bold for easy recognition if the mode is in a “MANAGE” mode;
waiting on the shared synchronizing object for current thread's matrixFlag's value turning into true and its sliceFlag's value turning into true and its latticeFlag's value turning into true, or a timeout is elapsed;
executing the print method of the ServletProcessor instance with the new key chain and the generated content for saving the generated content into the new buffer;
setting the value of next latticeFlag into true;
notifying all other threads waiting on the shared synchronizing object; otherwise
spawning a FeaMosaicHanger thread if the lattice representing a MosaicHanger; otherwise
spawning a FeaBox thread for the lattice if the slice involves a rectangle area and including three cells: a leftside cell, a rectangle area cell, and a rightside cell.

53. The method of claim 52, wherein said step of spawning a FeaMosaicHanger thread further comprising:
obtaining information associated with the MosaicHanger: a Mosaic and the hanging position of X value and Y value;
constructing the enclosing portion of an html cell element and the enclosing portion of an html table if the lattice is the last element in the last slice and embedding a remove button and a editing button showing the hanging information of X and Y values if the mode is in a “MANAGE” mode if the response is not a freameset html file;
finding out a list of MosaicHangers hanged on the Mosaic if the Mosaic is a nested Mosaic;
if the Mosaic is not a nested Mosaic,
constructing a new object array as a new key chain by copying all elements from the object array as a key chain passed into the FeaMosaicHanger thread and by adding a new object element as a new key representing a new buffer in the hierarchy of buffers;
spawning a FeaMosaic thread and passing the information of the Mosaic and the new key chain into the FeaMosaic thread together with the instance of HttpServletRequest, the instance of HttpServletResponse, the instance of ServletSession, the instance of ServletProcessor, and the instance of ServletBase;
waiting on the shared synchronizing object for current thread's matrixFlag's value turning into true and its sliceFlag's value turning into true and its latticeFlag's value turning into true, or a timeout is elapsed;
putting the new key and a new FeaFlag instance with a true value into the beginHashtable indicating the new buffer is ready for moving its saved content up to one level in the hierarchy of buffers;
notifying all other threads waiting on the shared synchronizing object;
waiting on the shared synchronizing object for a FeaFlag instance's value turning into true identified by the new key and stored in a memory block endHashtable of the ServletProcessor instance, or a timeout is elapsed;
executing the print method of the ServletProcessor instance with said enclosing portion and the object array as a key chain of the current FeaMosaicHanger thread;
setting the value of next latticeFlag into true and if the lattice is the last element of the slice setting the values of sliceFlag of next slice and latticeFlag of its first lattice into true and if the lattice is the last element of the last slice setting the value of the matrixFlagEnd into true;
notifying all other threads waiting on the shared synchronizing object; otherwise
instantiating a new instance of FeaFlag named subMatrixFlag marking the starting point of a branch of hierarchy of threads and passing it into the top thread of the branch of hierarchy of threads;
assigning the latticeFlag of the current FeaMosaicHanger thread to the subMatrixFlag and linking them together;
instantiating a new instance of FeaFlag named subMatrixFlagEnd passing it into the top thread of the branch of hierarchy of threads and marking the ending point of the branch of hierarchy of threads;
passing the object array as a key chain of the current FeaMosaicHanger thread into the top thread of the branch of hierarchy of threads;
spawning a new FeaMatrix thread for sorting the list of MosaicHangers hanged on the Mosaic and for processing, wherein the new FeaMatrix thread is the top thread of the branch of hierarchy of threads;
waiting for the new FeaMatrix thread's notification if the sorting is done or a timeout is elapsed then proceeds to next step;
waiting on the shared synchronizing object for current thread's matrixFlag's value turning into true and its sliceFlag's value turning into true and its latticeFlag's value turning into true, or a timeout is elapsed;
turning the value of the subMatrixFlag to true automatically since it is linked with the latticeFlag;
setting the value of first element of subSliceFlag of the subMatrixFlag to true;
setting the value of first element of subLatticeFlag of the first element of the subSliceFlag to true;
notifying all threads waiting on the shared synchronizing object;
waiting on the shared synchronizing object for notifications from other threads that the value of the subMatrixFlagEnd is turning true;
executing the print method of the ServletProcessor instance with said enclosing portion and the object array as a key chain of the current FeaMosaicHanger thread;
setting the value of next subLatticeFlag into true and if the lattice is the last element of the slice setting the values of subSliceFlag of next slice and subLatticeFlag of its first lattice into true and if the lattice is the last element of the last slice setting the value of the matrixFlagEnd into true;
notifying all other threads waiting on the shared synchronizing object.

54. The method of claim 53, wherein said step of spawning a FeaMosaic thread further comprising:
obtaining the Mosaic's binding information by its MosaicBinder;
if the Mosaic is bound to a ServletPresentation implementation class,
instantiating an instance of the ServletPresentation implementation class;
getting an object returned by executing the getPresentation method of the ServletPresentation instance with the key chain, wherein the returned object might be null if the method already saves its generated content into buffers associated with the key chain;
executing the print method of the ServletProcessor instance with the key chain and the returned object for saving the object into a buffer associated with the last key in the key chain;
executing the printed method of the ServletProcessor instance with the key chain for pushing up the content currently saved in the buffer associated with the last key up to one level in the hierarchy of buffers associated with the key chain; otherwise
instantiating an instance of the EntityPresentation implementation class;
getting an object returned by executing the getPresentation method of the EntityPresentation instance with the key chain and an identifier, wherein the returned object might be null if the method already saves its generated content into buffers associated with the key chain;
executing the print method of the ServletProcessor instance with the key chain and the returned object for saving the object into a buffer associated with the last key in the key chain;
executing the printed method of the ServletProcessor instance with the key chain for pushing up the content currently saved in the buffer associated with the last key up to one level in the hierarchy of buffers associated with the key chain.

55. The method of claim 54, wherein said EntityPresentation implementation class represents any one of a AccessGroup, a Document, a Music, a Picture, a Video, a Favorite, a Webpage, a SimpleText for plain text, a HtmlText for html text, a SearchBox for search function, a function for consuming a web service;

56. The method of claim 52, wherein said step of spawning a FeaBox thread further comprising:
constructing the enclosing portion of an html cell element and the enclosing portion of an html table if the lattice is the last element in the last slice if the response is not a freameset html file;
instantiating a new instance of FeaFlag named subMatrixFlag marking the starting point of a branch of hierarchy of threads and passing it into the top thread of the branch of hierarchy of threads;
assigning the latticeFlag of the current FeaBox thread to the subMatrixFlag and linking them together;
instantiating a new instance of FeaFlag named subMatrixFlagEnd passing it into the top thread of the branch of hierarchy of threads and marking the ending point of the branch of hierarchy of threads;
if the lattice cell is the rectangle area cell,
finding out a list of MosaicHangers hanged on the ServletPresentation implementation class;
if the list of MosaicHangers is not empty,
passing the object array as a key chain of the current FeaBox thread into the top thread of the branch of hierarchy of threads;
spawning a new FeaMatrix thread for sorting the list of MosaicHangers and for processing, wherein the new FeaMatrix thread is the top thread of the branch of hierarchy of threads;
waiting for the new FeaMatrix thread's notification if the sorting is done or a timeout is elapsed then proceeds to next step;
waiting on the shared synchronizing object for current FeaBox thread's matrixFlag's value turning into true and its sliceFlag's value turning into true and its latticeFlag's value turning into true, or a timeout is elapsed;
turning the value of the subMatrixFlag to true automatically since it is linked with the latticeFlag;
setting the value of first element of subSliceFlag of the subMatrixFlag to true;
setting the value of first element of subLatticeFlag of the first element of the subSliceFlag to true;
notifying all threads waiting on the shared synchronizing object;
waiting on the shared synchronizing object for notifications from other threads that the value of the subMatrixFlagEnd is turning true;
executing the print method of the ServletProcessor instance with said enclosing portion and the object array as a key chain of the current FeaBox thread;
setting the value of next latticeFlag into true and if the lattice is the last element of the slice setting the values of sliceFlag of next slice and latticeFlag of its first lattice into true and if the lattice is the last element of the last slice setting the value of the current FeaBox thread's matrixFlagEnd into true;
notifying all other threads waiting on the shared synchronizing object; otherwise
waiting on the shared synchronizing object for current FeaBox thread's matrixFlag's value turning into true and its sliceFlag's value turning into true and its latticeFlag's value turning into true, or a timeout is elapsed;
constructing a new object array as a new key chain by copying all elements from the object array passed into the FeaBox thread and by adding a new object element as a new key representing a new buffer in a hierarchy of buffers;
putting the new key and a new FeaFlag instance with a true value into the beginHashtable indicating the new buffer is ready for moving its saved content up to one level in the hierarchy of buffers;
instantiating an instance of ServletPresentation implementation class by using the fully qualified class name of the instance of ServletBase;
getting an object returned by executing the getPresentation method of the ServletPresentation instance with the new key chain, wherein the returned object might be null if the method already saves its generated content into buffers associated with the new key chain;
executing the print method of the ServletProcessor instance with the new key chain and the returned object for saving the object into the new buffer;
executing the printed method of the ServletProcessor instance with the new key chain for pushing up the content currently saved in the new buffer up to one level in the hierarchy of buffers;
executing the print method of the ServletProcessor instance with said enclosing portion and the object array as a key chain of the current FeaBox thread;
setting the value of next latticeFlag into true and if the lattice is the last element of the slice setting the values of sliceFlag of next slice and latticeFlag of its first lattice into true and if the lattice is the last element of the last slice setting the value of the current FeaBox thread's matrixFlagEnd into true;
notifying all other threads waiting on the shared synchronizing object; otherwise
finding out a list of MosaicHangers on either the leftside cell or the rightside cell;
if the list of MosaicHangers is not empty,
passing the object array as a key chain of the current FeaBox thread into the top thread of the branch of hierarchy of threads;
spawning a new FeaMatrix thread for sorting the list of MosaicHangers and for processing, wherein the new FeaMatrix thread is the top thread of the branch of hierarchy of threads;
waiting for the new FeaMatrix thread's notification if the sorting is done or a timeout is elapsed then proceeds to next step;
waiting on the shared synchronizing object for current FeaBox thread's matrixFlag's value turning into true and its sliceFlag's value turning into true and its latticeFlag's value turning into true, or a timeout is elapsed;
turning the value of the subMatrixFlag to true automatically since it is linked with the latticeFlag;
setting the value of first element of subSliceFlag of the subMatrixFlag to true;
setting the value of first element of subLatticeFlag of the first element of the subSliceFlag to true;
notifying all threads waiting on the shared synchronizing object;
waiting on the shared synchronizing object for notifications from other threads that the value of the subMatrixFlagEnd is turning true;
executing the print method of the ServletProcessor instance with said enclosing portion and the object array as a key chain of the current FeaBox thread;
setting the value of next latticeFlag into true and if the lattice is the last element of the slice setting the values of sliceFlag of next slice and latticeFlag of its first lattice into true and if the lattice is the last element of the last slice setting the value of the current FeaBox thread's matrixFlagEnd into true;
notifying all other threads waiting on the shared synchronizing object; otherwise
waiting on the shared synchronizing object for current FeaBox thread's matrixFlag's value turning into true and its sliceFlag's value turning into true and its latticeFlag's value turning into true, or a timeout is elapsed;
executing the print method of the ServletProcessor instance with said enclosing portion and the object array as a key chain of the current FeaBox thread;
setting the value of next latticeFlag into true and if the lattice is the last element of the slice setting the values of sliceFlag of next slice and latticeFlag of its first lattice into true and if the lattice is the last element of the last slice setting the value of the current FeaBox thread's matrixFlagEnd into true;
notifying all other threads waiting on the shared synchronizing object.

57. The method of claim 46, wherein said step of executing a end method of ServletBase further comprising:
executing the end( ) method of the instance of ServletProcessor.

58. The method of claim 57, wherein said step of executing the end( ) method further comprising:
waiting on the shared synchronizing object for the value of a key in a memory block beginHashtable turning into true or a timout is elapsed;
sending out and clearing contents still resided in a hierarchy of buffers;
notifying all other threads waiting on the shared synchronizing object;
generating the closing portion of an html file;
flushing out the generated closing portion to a user;
spawning a new thread to send out a URL and request said web container for generating a semi static file if indicated by a key saved in the beginHashtable;
putting a key and an instance of FeaFlag with value of true into a memory block endHashtable;
notifying all other threads waiting on the shared synchronizing object.

59. A method of tracking and maintaining the change of frame size and URL of frames in a frameset web page by a web container and Ajax technology where a user browses and interacts with the web page through a browser which communicates with the web container either in the same computer machine or in a remote computer machine, said method comprising:
receiving a user's request on said web page;
creating a memory block requestHashtable storing accumulative request-scope wide information during the lifetime of a session;
saving the requestHashtable in the session, wherein the requestHashtable is identified and retrieved by the request URI;
generating said web page and loading initial layout of frames and URL of each frame;
creating an object array to store ID information of framesets, a second object array to store ID information of frames, a third object array to store URL information of frames, and a fourth object array to store layout information of frames, wherein the fourth object array is a two dimensional object array with first dimension identifying a frame and second dimension storing the width and height information of the frame;
storing all four object array in the requestHashtable with four different keys;
sending said web page to the user for browse and interaction;
sending back a frame's URL by Ajax to the same request URI upon loading the frame either by initial loading or by clicking through to a new location, and triggered by an onload event of the browser;
saving the new information sent back by Ajax into the URL information object array;
sending back all frames' width and height information by Ajax to the same request URI upon a user adjusting the layout of frames, and triggered by an onresize event of the browser;
saving the width and height information sent back by Ajax into the fourth object array;
retrieving the URL and size information of each frame upon a user's revisit;
reconstructing the layout of frames;
generating said web page which reflects the current layout of frames and URL of each frame;
